(19) United States
(12) Patent Application Publication
(10) Pub. No.: US 2009/0024769 A1
(43) Pub. Date: Jan. 22, 2009

(54) OPERATING DEVICE FOR ELECTRONIC EQUIPMENT, OPERATING SYSTEM, IMAGE PROCESSING APPARATUS, INFORMATION DISPLAY APPARATUS, AND EXTERNAL EQUIPMENT CONNECTING DEVICE

(76) Inventors: Atsuhito NAKATANI, Yamato-Koriyama-shi (JP); Takahisa Sato, Yamato-Koriyama-shi (JP); Masashi Toyoda, Nara-shi (JP)

Correspondence Address: MARK D. SARALINO ( SHARP );RENNER, OTTO, BOISSELLE & SKLAR, LLP, 1621 EUCLID AVENUE, 19TH FLOOR, CLEVELAND, OH, 44115, US

(21) Appl. No.: 12/113,978

(22) Filed: May 2, 2008

(30) Foreign Application Priority Data
May 8, 2007 (JP) 2007-123214
Jun. 18, 2007 (JP) 2007-159630

(51) Int. Cl. G06F 13/00

(52) U.S. Cl. 710/16

(57) ABSTRACT

An operating device includes a connecting portion connectable to an external memory device storing operation data, an operation detecting portion that detects a positional change of the enclosure of the connected external memory device as an operation carried out on the external memory device, and an operation control portion that gives a command for executing a given action to an electronic equipment (image processing apparatus, etc.) according to the detection result. The above operation data is the data that presets a command for causing the electronic equipment to execute a specific action in correspondence to an operation on the external memory device. The operation control portion reads operation data out of the connected external memory device, and gives a command for executing a specific action to a main CPU of the electronic equipment based on an operation detected by the operation detecting portion and the read operation data.

### CROSS-NOTING PARAGRAPH

This Nonprovisional application claims priority under 35 U.S.C. §119 (a) on Patent Application No. 2007-123214 filed in JAPAN on May 8, 2007 and Patent Application No. 2007-159630 filed in JAPAN on Jun. 18, 2007 the entire contents of which are hereby incorporated herein by references.

### FIELD OF THE INVENTION

The present invention relates generally to an operating device for electronic equipment, an operating system, and an image processing apparatus having the operating device and operating system, and, more particularly, to an operating device that gives a command for causing electronic equipment to execute a given action to the electronic equipment, an electronic equipment system including the operating device and an external memory device, and an image processing apparatus having the operating device and the electronic equipment system.

The present invention relates further to an image display apparatus that reads out a data file stored in an external memory device to display a desired image, and an external equipment connecting device used for the image display apparatus.

### BACKGROUND OF THE INVENTION

In use of various electronic equipment, a user carries out a given operation on electronic equipment and the electronic equipment executes a given function according to the operation. For example, the electronic equipment receives an operation by the user through such an operation means as a switch and a button, and causes a display means to display a menu to receive operation input from a touch panel, pointing device, keyboards, etc.

Many electronic equipment as described above have multiple functions. The multiple functions, however, may result in complicated switches and display of menus for executing a given operation. This leads to the problem that a user cannot quickly carry out a desired operation.

In use of an information display apparatus that is connected to a display means such as liquid crystal display and projector to display a desired image, a user carries out a given operation on the information display apparatus and the information display apparatus executes a given function according to the operation. For example, the information display apparatus receives an operation by the user through such an operation means as a switch and a button, and causes a display means to display a menu to receive operation input from a touch panel, pointing device, keyboards, etc.

Many information display apparatuses as described above have multiple functions. The multiple functions, however, may result in complicated switches and display of menus for executing a given operation. This leads to the problem that a user cannot quickly carry out a desired operation. When a presentation is made using such an information display apparatus, particularly, a presenter is often not allowed to use a unit the presenter is accustomed to, but may have to use an apparatus prepared in the presentation site, and in that case, the fact that the user is incapable of quickly operating the apparatus constitutes a problem.

To deal with such a problem, Japanese Laid-Open Patent Publication No. 01-51768 discloses an apparatus that carries out setting by reading setting information out of a removable memory card storing the setting information on an operation portion.

Japanese Laid-Open Patent Publication No. 2000-305761 discloses an information processing apparatus that upon detecting attachment of a memory medium, specifies a program corresponding to the attached memory medium and starts the program.

As describe above, when a user operates electronic equipment having multiple functions, the user faces the problem that switches and display of menus for carrying out a given operation are so complicated as to disable the user from quickly finding a desired switch, display of menu, etc., and that multifunctionality, therefore, rather impairs the operability of the electronic equipment or an information display apparatus. In using the apparatus disclosed in Japanese Laid-Open Patent Publication No. 01-51768, the user has to find a specific operating switch or memorize the position of switches, thus having difficulty in carrying out intuitive operation.

### SUMMARY OF THE INVENTION

An object of the present invention is to provide an operating device for electronic equipment that allows execution of intuitive and quick operation, an operating system and an image processing apparatus that have the operating device, an information display apparatus that allows execution of intuitive and quick operation, and an external equipment connecting device used for the information display apparatus.

Another object of the present invention is to provide an operating device for electronic equipment that causes the electronic equipment to execute a given action, comprising a connecting portion connectable to an external memory device; an operation detecting portion that detects a positional change of an enclosure of an external memory device connected to the connecting portion as an operation carried out on the external memory device; and a control portion that sends a command for executing a specific action to the electronic equipment in correspondence to a detection result from the operation detecting portion, wherein the control portion gives a command corresponding to an operation detected by the operation detecting portion to the electronic equipment based on operation data that is set so that when an operation on the external memory device is detected, a command corresponding to the operation is specified.

Another object of the present invention is to provide the operating device for electronic equipment, wherein the operation data is stored in the external memory device, and wherein the control portion reads out the operation data from the connected external memory device, and sends a command corresponding to an operation detected by the operation detecting portion to the electronic equipment based on the read operation data.

Another object of the present invention is to provide the operating device for electronic equipment, comprising a detecting portion that detects whether the external memory device is connected, wherein when the detecting portion detects connection of the external memory device, the control portion changes an operational mode to a mode for carrying out an action of sending a command corresponding to an operation detected by the operation detecting portion to the electronic equipment based on the operation data.

Another object of the present invention is to provide the operating device for electronic equipment, wherein the operation detecting portion detects a tilt direction of the enclosure of the external memory device as the positional change.

Another object of the present invention is to provide the operating device for electronic equipment, wherein the operation detecting portion detects a tilt angle of the enclosure of the external memory device as the positional change.

Another object of the present invention is to provide the operating device for electronic equipment, wherein the operation detecting portion detects an angle of rotation around a rotating shaft along the longitudinal direction of the enclosure of the external memory device as the positional change.

Another object of the present invention is to provide the operating device for electronic equipment, wherein the control portion determines whether an operation carried out on the external memory device continues for a given time, and changes a command to be given to the electronic equipment depending on a case of continuation of the operation for the given time and a case of continuation of the operation not for the given time.

Another object of the present invention is to provide the operating device for electronic equipment, wherein when the operation data is stored in the external memory device, the control portion carries out an action of sending a command corresponding to an operation detected by the operation detecting portion to the electronic equipment based on operation data read out of the external memory device, and wherein when the operation data is not stored in the external memory device, the control portion carries out an action of sending a command corresponding to an operation detected by the operation detecting portion to the electronic equipment based on predetermined operation data.

Another object of the present invention is to provide an operating system for electronic equipment, comprising the operating device for electronic equipment and an external memory device connectable to the operating device for electronic equipment, wherein the external memory device has a display portion capable of displaying a list of data stored in the external memory device, and wherein a command for displaying the data list stored in the external memory device and a command for selecting a piece of data for causing the electronic equipment to carry out a given action from the data list displayed by the display portion are set in the operation data in correspondence to an operation on the external memory device.

Another object of the present invention is to provide an image processing apparatus comprising the operating device for electronic equipment.

Another object of the present invention is to provide an image processing apparatus comprising the operating system for electronic equipment.

Another object of the present invention is to provide an information display apparatus comprising an information processor that carries out control for reading out operation data and a data file stored in an external memory device to display a desired image; and an external equipment connecting device including a connecting portion connectable to an external memory device, and an operation detecting portion that detects a positional change of an enclosure of an external memory device connected to the connecting portion as an operation carried out on the external memory device, the operation detecting portion being attached integrally to the connecting portion, wherein the operation data is data that is preset so that when the operation detecting portion detects an operation on an external memory device, a command corresponding to the operation is specified, and wherein the information processor reads the operation data out of an external memory device connected to the connecting portion, and executes a command corresponding to an operation detected by the operation detecting portion based on the read operation data.

Another object of the present invention is to provide the information display apparatus, wherein the information processor changes a command system for executing a specific action in correspondence to application software running, and executes a command according to a detection result from the operation detecting portion.

Another object of the present invention is to provide the information display apparatus, comprising a plurality of the external equipment connecting devices, wherein the information processor can determine possibility and impossibility of operation on each of the external equipment connecting devices.

Another object of the present invention is to provide the information display apparatus, wherein when given operation data is not stored in an external memory device, the information processor executes processing based on a given command system set in the external memory device.

Another object of the present invention is to provide the information display apparatus, wherein when detecting connection of a plurality of external memory devices having stored therein the operation data, the information processor enables operation of the external equipment connecting device connected to an external memory device based on priority registered with the external memory device.

Another object of the present invention is to provide the information display apparatus, wherein when detecting connection of a plurality of external memory devices having stored therein operation data, the information processor enables operation of the external equipment connection device connected to an external memory device based on priority registered with the external equipment connecting device.

Another object of the present invention is to provide the information display apparatus, wherein when detecting an authentication ID stored in an external memory device to be a usable authentication ID registered with the external memory device, the information processor enables operation of the external equipment connecting device connected to the external memory device.

Another object of the present invention is to provide the information display apparatus, wherein the information processor reads out identification information of a data file stored in an external memory device, and when the read identification information matches a specific file format, enables operation of the external equipment connecting device connected to the external memory device.

Another object of the present invention is to provide the information display apparatus, wherein when detecting continuation of a given operation on the external equipment connecting device for a given time or longer, the information processor executes another processing.

Another object of the present invention is to provide an external equipment connecting device used for an information display apparatus that reads out operation data and a data file stored in an connected external memory device to display a desired image, comprising a connecting portion connected separably to an external memory device; and an operation detecting portion that is attached integrally to the connecting portion and that detects a positional change of an enclosure of an external memory device connected to the connecting portion as an operation carried out on the external memory device.

Another object of the present invention is to provide the external equipment connecting device, wherein the operation detecting portion includes a mechanism that when an operation is carried out on an external memory device connected to the connecting portion, causes the connecting portion to tilt with the external memory device, and a plurality of switches each of which detects a tilt of the connecting portion in each direction.

Another object of the present invention is to provide the external equipment connecting device, comprising a communication portion that enables data communication between an external memory device and an information display apparatus.

Another object of the present invention is to provide the external equipment connecting device, comprising a detecting portion that detects possibility and impossibility of the data communication.

### BRIEF DESCRIPTION OF THE DRAWINGS

FIG. 1 depicts the outline configuration of an image processing apparatus to which an operating device for electronic equipment of the present invention can be applied;

FIG. 2 is a block diagram of the electrical configuration of the image processing apparatus of FIG. 1;

FIG. 3 is a diagram for further explaining a detecting portion of FIG. 2 that detects the possibility or impossibility of data communication with an external memory device;

FIG. 4 is a block diagram of a configurative example of the external memory device;

FIG. 5 depicts a configurative example of a connecting portion for connection to the external memory device in the operating device for the electronic equipment of the present invention;

FIG. 6 depicts a configurative example of the connecting portion for connection to the external memory device in the operating device for the electronic equipment of the present invention;

FIGS. 7A and 7B depict the external memory device that is put in a tilted state by an operation on the external memory device;

FIGS. 8A and 8B depict a more specific configurative example of the connecting portion for connection to the external memory device in the operating device for the electronic equipment of the present invention;

FIG. 9 is a diagram for explaining a tilted state of the external memory device having the configuration of FIGS. 8A and 8B;

FIGS. 10A and 10B depict examples of operation data stored in the external memory device;

FIG. 11 is a flowchart for explaining an example of the processing carried out by the image processing apparatus having the operating device for the electronic equipment of the present invention;

FIG. 12 is a flowchart for explaining another example of the processing carried out by the image processing apparatus having the operating device for the electronic equipment of the present invention and shows another example of the processing carried out at step S4 of FIG. 11;

FIG. 13 depicts another configurative example of the connecting portion for connection to the external memory device in the operating device for the electronic equipment of the present invention;

FIG. 14 depicts still another configurative example of the connecting portion for connection to the external memory device in the operating device for the electronic equipment of the present invention;

FIG. 15 depicts an example of pulse waveform that is output from a photointerrupter as the external memory device connected to the connecting portion is tiled;

FIGS. 16A and 16B depict still another configurative example of the connecting portion for connection to the external memory device in the operating device for the electronic equipment of the present invention;

FIG. 17 is an explanatory view of one embodiment of an operating system for the electronic equipment of the present invention;

FIG. 18 is a schematic diagram of an information display system composed of an information display apparatus and a display device of the present invention;

FIG. 19 is a block diagram of the overall configuration of the information display apparatus according to an embodiment of the present invention;

FIG. 20 is an explanatory view of a detecting portion that detects the possibility or impossibility of data communication with an external memory device;

FIG. 21 depicts a configurative example of the external memory device (USB memory);

FIGS. 22A to 22C depict an example of the mechanism of an operation detecting portion in an external equipment connecting device;

FIG. 23 depicts a control flow of control carried out by an information processor;

FIGS. 24A to 24C depict examples of operation data; and

FIG. 25 depicts a control flow when a subroutine is added to the control flow shown in FIG. 23.

### PREFERRED EMBODIMENTS OF THE INVENTION

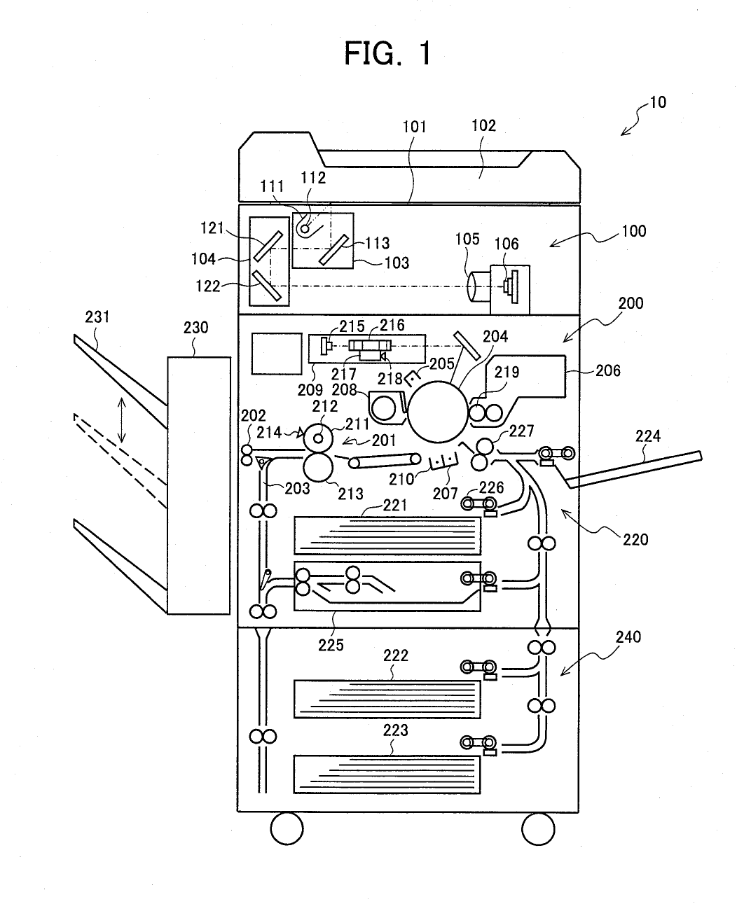

FIG. 1 depicts the outline configuration of an image processing apparatus to which an operating device for electronic equipment of the present invention can apply.

The image processing apparatus 10 includes an image reading portion 100 located on the upper part of the image processing apparatus 10, an image forming portion 200 located on the central part of the same, and a paper feeding portion 220 located on the lower part of the same. A transparent glass document plate 101 is disposed on the upper face of the image processing apparatus 10, and an automatic document feeder 102 which automatically feeds a plurality of documents set on a document set tray one by one to the document plate 101 is placed on the document plate 101. A post-processing device 230 is attached to one side of the image forming portion 200, and a multitier paper feeding unit 240 serving also as a mounting platform is disposed under the paper feeding portion 220.

The image reading portion 100 under the document plate has a first scanning unit 103, a second scanning unit 104, an optical lens 105, and a CCD line sensor 106 that is a photoelectric conversion device. The image reading portion 100, operating in correlation with the automatic document feeder 102, relatively scans an image on a document placed on the document plate 101 at a given exposure position to read the image.

The first scanning unit 103 is equipped with a light source lamp unit 111 that exposures a document surface to light, and a first mirror 113 that reflects the reflected light from the document in a given direction. The exposure light quantity of the light source lamp unit 111 is detected by a light quantity sensor. The second scanning unit 104 is equipped with a second mirror 121 and a third mirror 122 that lead the reflected light from the document reflected by the first mirror 113 to the CCD line sensor 106 that is the photoelectric conversion device. The optical lens 105 focuses the reflected light from the document to form an image on a light-receiving face of the CCD line sensor 106.

The image forming portion 200 has an electrifying unit 205 that electrifies a photosensitive drum 204 to give it a given potential, a laser scan unit (LSU) 209 that emits laser light in correspondence to image data transferred from the image reading portion 100 or from an external device to form a static latent image on the photosensitive drum 204, a developing unit 206 that supplies toner to the static latent image formed on the photosensitive drum 204 via developing rollers 219 to develop the static latent image into a toner image, a transferrer 207 that transfers the toner image formed on the photosensitive drum 204 to a paper, a cleaner 208 that recovers toner, etc., remaining on the photosensitive drum 204 after a transfer process, and a separator 210 that separates the paper from the photosensitive drum 204 after the transfer process.

The laser scan unit 209 contains a semiconductor laser 215 that emits laser light which is modulated based on image data, a polygon mirror 216 that revolves to polarize laser light in a main scan direction, and a group of lenses, which are not shown. The polygon mirror 216 is driven by a motor 217, the revolution speed of which is detected by a speed sensor 218.

The image forming portion 200 also has a fixing unit 201 that heats and pressurizes the paper bearing the transferred toner image to fix the toner image to the paper. The fixing unit 201 is composed of a pair of an upside heating roller 211 and an underside pressure roller 213. The heating roller 211 has a heater, and the temperature of the heating roller 211 is detected by a temperature sensor 214. At the ejection side of the fixing unit 201, a switchback path 203 is formed, which reverses the front and rear of the paper in a double-face image formation mode in which an image is formed on both faces of the paper.

The paper, to which the toner image is fixed at the fixing unit 201, is sent through the switchback path 203 when necessary, and is guided by paper ejecting rollers 202 to the post-processing device 230, where the paper is subjected to post-processing such as stapling and punching, and then is ejected onto a tray 231.

The paper feeding portion 220 has a manual-feeding tray 224 attached to a side of the body of the image processing apparatus 10, a double-face unit 225, a paper feeding tray 221, and paper feeding trays 222 and 223 that are incorporated in the multitier paper feeding unit 240. In these paper feeding trays 221 to 223 and the manual-feeding tray 224, stacks of papers are stored. The paper feeding portion 220 also has a transporting means, such as rollers, that transports a paper fed from the paper feeding trays 221 to 223 or the manual-feeding tray 224 to a transfer position between the photosensitive drum 204 and the transferrer 207 in the image forming portion 200.

The double-face unit 225 is connected to the switchback path 203 for reversing a paper, and temporarily reserves the paper with reversed front and back faces in the double-face image formation mode. The double-face unit 225 can be replaced with an ordinary paper feeding tray.

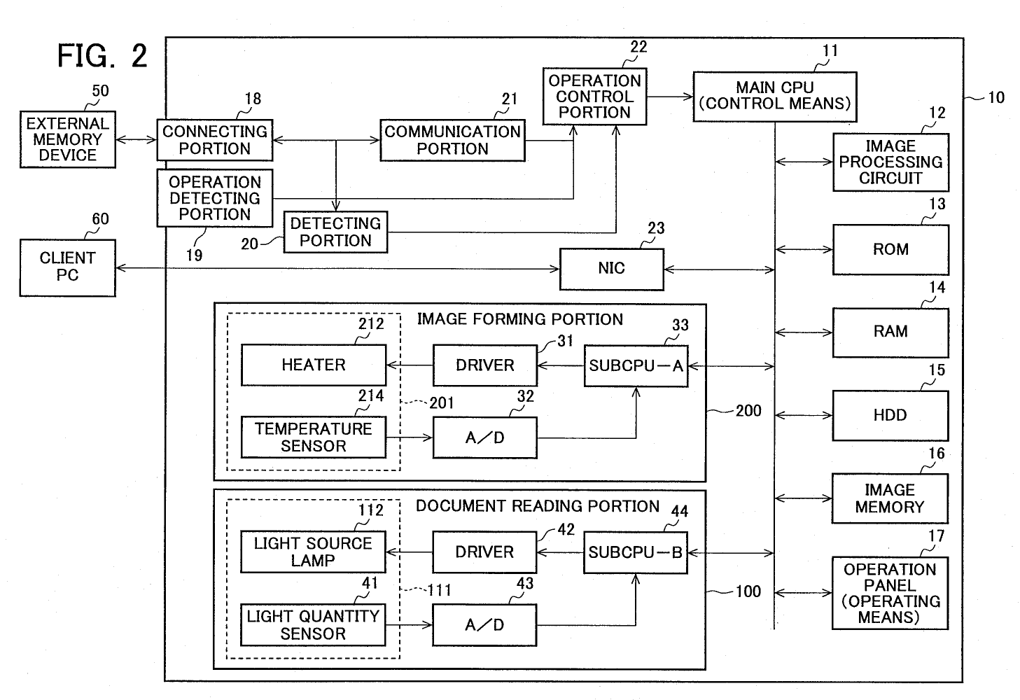

FIG. 2 is a block diagram of the electrical configuration of the image processing apparatus of FIG. 1.

The image processing apparatus 10 includes a main CPU 11 that serves as a control means and that has a ROM 13 and a RAM 14. The main CPU 11 is connected to an image processing circuit 12, an HDD 15, an image memory 16, an operating means (operation panel) 17, a detecting portion 20, a communication portion 21, an NIC 23, a subCPU-A 33, and a subCPU-B44.

The main CPU 11 controls input/output devices in an integrated manner according to a program stored in the ROM 13 in advance, and temporarily stores input/output data in a given memory area of the RAM 14 during control. The image memory 16 stores image data output from the image processing circuit 12. The operating means (operation panel) 17 has input keys and a liquid crystal display panel, displays the status of the image processing apparatus 10, an available paper size, a copy magnification rate, etc., and receives operation by a user through the input keys. The liquid crystal display panel may be a liquid crystal touch panel that enables input operation by touching a liquid crystal screen.

An external memory device 50 has the processing modes consisting of a document reading mode in which image data read by the image reading portion 100 is stored in the external memory device 50 (SCAN TO USB), an image formation mode in which the image forming portion 200 forms an image from the image data stored in the external memory device 50 (USB TO PRINT), a mode in which data stored in the HDD 15 in the image processing apparatus 10 is stored in the external memory device 50 (FILE TO USB), and a mode in which data stored in the external memory device 50 is stored in the HDD 15 in the image processing apparatus 10 (USB TO FILE). A USB (Universal Serial Bus) memory is used as the external memory device 50.

The communication portion 21 is an interface that carries out data communication between the external memory device 50 (device capable of USB connection) and the main CPU 11. A connecting portion 18 is a USB standard connector connected to the external memory device 50. The detecting portion 20 is a circuit that detects the possibility or impossibility of data communication with the external memory device 50, and will be described in detail later.

To the connecting portion 18, the external memory device 50 conforming to the USB standard can be connected. The external memory device 50 is connected to the image processing apparatus 10, and when supplied with power from the image processing apparatus 10, transmits device identification data indicating the type of the external memory device to the image processing apparatus 10 to which the external memory device is connected. The image processing apparatus 10 is then allowed to carry out control depending on the type of the external memory device 50 based on the device identification data transmitted from the external memory device 50.

The NIC (Network Interface Card) 23 is a communication means that carries out network communication with a client PC 60. The image processing apparatus 10 carries out printing based on print data transferred from the client PC 60, or transfers image data obtained by image reading to the client PC 60 via the NIC 23.

An operation control portion 22 is a circuit that controls an operation carried out by using the external memory device 50, and will be described in detail later.

The image forming portion 200 is controlled by the subCPU-A33, and includes a heater 212, a temperature sensor 214, a driver 31, and an A/D converter 32. The temperature sensor 214 detects the temperature of the heating roller 211 at the fixing unit 201, and outputs temperature data to the subCPU-A33.

The main CPU 11 transmits a given warmup command to the subCPU-A33 in carrying out a first return processing. Receiving the given warmup command from the main CPU 11, the subCPU-A33 energizes the heater 212, and, based on temperature data from the temperature sensor 214, controls energization of the heater 212 so as to keep the surface temperature of the heating roller 211 heated by the heater 212 at a prescribed temperature. When the surface temperature of the heating roller 211 reaches the prescribed temperature, the subCPU-A33 determines that a processable state (ready state) has been achieved and informs the main CPU 11 of the processable state.

The image forming portion 100 is controlled by the subCPU-B44, and includes a light source lamp 112, a light quantity sensor 41, a driver 42, and an A/D converter 43. The light quantity sensor 41 detects the quantity of light emitted from the light source lamp 112 of the light source lamp unit 111, and inputs light quantity data to the subCPU-B44. The main CPU 11 transmits a given warmup command to the subCPU-B44 in carrying out a second return processing. Receiving the given warmup command from the main CPU 11, the subCPU-B44 energizes the light source lamp 112, and, based on light quantity data from the light quantity sensor 41, controls energization of the light source lamp 112 so as to keep the light quantity of the light source lamp 112 at a prescribed light quantity. When the light quantity of the light source lamp 112 reaches the prescribed light quantity, the subCPU-B44 determines that the processable state (ready state) has been achieved, and informs the main CPU 11 of the processable state.

The driver 42 drives the light source lamp 112 of the light source lamp unit 111 based on control data output from the subCPU-B44. The driver 31 drives the heater 212 built in the heating roller 211 of the fixing unit 201 based on control data output from the subCPU-A33.

The subCPU-A33 and the subCPU-B44 are connected also to a number of input/output devices such as motors, clutches, solenoids, and sensors disposed in the image forming portion and the document reading portion that operate in a document reading processing and an image forming processing. The subCPU-A33 and the subCPU-B44 read the detected data from sensors at a given timing when the document reading processing and the image forming processing are carried out, and drive motors, etc., according to the detected data.

In the above configuration, the operating device for the electronic equipment is incorporated in the image processing apparatus, and the image processing apparatus is equivalent to the electronic equipment operated by the operating device. The operating device for the electronic equipment of the present embodiment includes the connecting portion 18 that can be connected to the external memory device 50 having operation data stored thereon, an operation detecting portion 19 that detects a positional change of the enclosure of the external memory device 50 connected to the connecting portion 18 as an operation carried out on the external memory device 50, and a control portion that, depending on a detection result from the operation detecting portion 19, gives a command for executing a given action to the electronic equipment. This control portion is equivalent to the operation control portion 22.

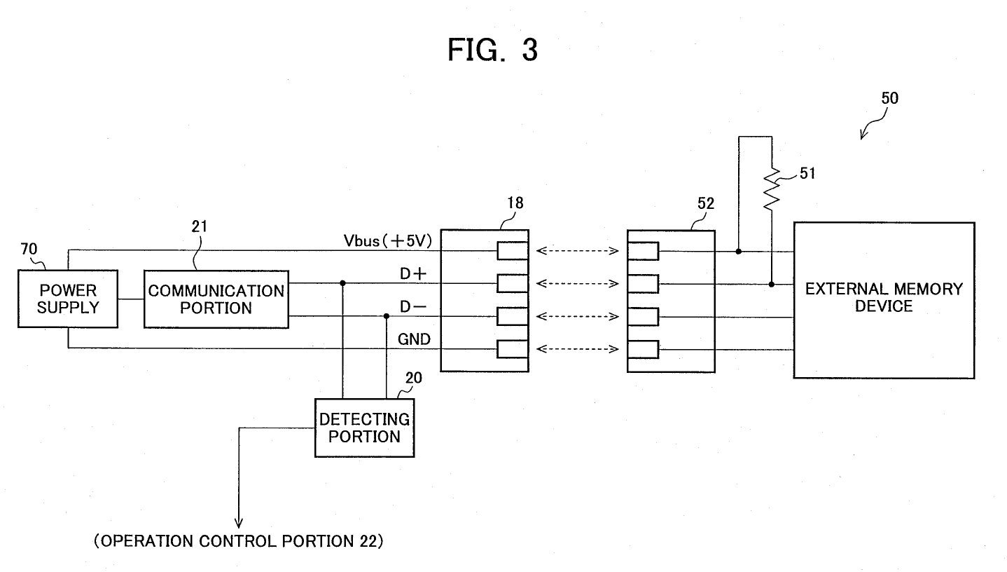

FIG. 3 is a diagram for further explaining the detecting portion of FIG. 2 that detects the possibility or impossibility of data communication with the external memory device.

A Vbus is a line (+5V) through which power is supplied to the external memory device 50. The image processing apparatus 10 has a power supply, which supplies power to the external memory device 50 via the Vbus. At the side of the external memory device 50, a pull-up resistance 51 is connected to a data input/output terminal D+ to pull up its voltage to the voltage of the Vbus. The pull-up resistance 51 may be connected to a data input/output terminal D−.

When a connector 52 of the external memory device 50 is connected to the connecting portion 18 of the image processing apparatus 10, the data input/output terminal D+ or the data input/output terminal D− comes to have a voltage virtually equal to the voltage of the Vbus. The detecting portion 20 detects the voltage of the data input/output terminal D+ and that of the data input/output terminal D−, and when finding the voltages of the data input/output terminal D+ and the data input/output terminal D− to be virtually equal to the voltage of the Vbus, informs the operation control portion 22 that data communication between the external memory device 50 and the image processing apparatus 10 is now possible.

### <Copy Mode>

The processing carried out in a copy mode by the image processing apparatus 10 having the above configuration will be described. The processing carried out in the copy mode include the image reading processing of reading an image on a document, and the image forming processing of copying the read image onto a paper.

In the copy mode, a document to be copied is placed on the document plate 101 of the image reading portion 100, and a user presses a condition input key (for inputting the number of copies, a copy magnification rate, etc.) on the operation panel. The user then presses a start key to start copy operation including the image reading processing and the image forming processing.

In the image processing apparatus 10, the press of the start key causes a main driving motor (not shown) to start virtually at the same time of the key pressing, which causes each driving gear to revolve. Subsequently, paper feeding rollers 226 revolve to feed a paper, which is transported through a transport path to registration rollers 227. At the registration rollers 227, the paper comes to a temporal stop to synchronize with the front end of an image on the photosensitive drum 204, and the front end of the paper is pressed uniformly to the registration rollers 227 and adjusted the position of the paper front end.

In the image reading portion 100, to obtain image information through document reading, the light source lamp 112 of the light source lamp unit 111 is turned on and the scanning unit 103 travels to start exposure scanning. Light emitted from the light source lamp unit 111 is reflected on a document's image surface and the reflected light is reflected at the mirrors 112, 121, and 122 and further travels through the optical lens 105 to reach the CCD line sensor 106, which reads the received reflected light as image information. The read image information is converted into the image data that is digital data at the image processing circuit 12. The converted image data is subjected to image processing under a set condition and is stored temporarily in the image memory 16, and then is supplied to the LSU 209 as the image data.

The surface of the photosensitive drum 204 revolving at a given speed is supplied with charges from the electrifying unit 205 and electrified uniformly to a given charged voltage. The LSU 209 drives the semiconductor laser 215 based on image data supplied from the main CPU 11, and emits laser light modulated through the image data onto the surface of the photosensitive drum 204 via the polygon mirror 216 revolving at a given speed. The emission of laser light by the LSU 209 forms an electrostatic latent image based on the image data on the surface of the photosensitive drum 204. The surface of the photosensitive drum 204, where the electrostatic latent image is formed, is supplied with toner from the developing unit 206, which develops the electrostatic latent image into a toner image.

The registration rollers 227, which start revolving in synchronization with the revolution of the photosensitive drum 204, send a paper in between the photosensitive drum 204 and the transferrer 207, where the transferrer 207 transfers the toner image carried on the surface of the photosensitive drum 204 to the paper. Toner remaining on the surface of the photosensitive drum 204 together with paper powder, etc., are removed and recovered by the cleaner 208.

The paper bearing the toner image transferred thereto is transported to the fixing unit 201, where the paper is heated and pressurized while passing through between the heating roller 211 and the pressure roller 213. The toner image transferred to the paper melts under pressure and heat applied by the paired rollers 211 and 213, and is fixed firmly to the paper surface. The paper bearing the toner image fixed thereto is sent through ejection rollers 202, and is ejected to the post-processing device 230.

### <Print Mode>

The image processing apparatus 10 transfers print data that is input from the client PC 60 via the NIC 23 and image data stored in the external memory device 50 that is connected to the apparatus 10 via the communication portion 21, to the LSU 209 incorporated in the image forming apparatus 200 to execute printing.

### <Scan Mode>

The image processing apparatus 10 transfers document image data read by the image reading portion 100 and stored in the image memory 16 to the client PC 60 via the NIC 23, or to the external memory device 50 connected to the apparatus 10 via the communication portion 21.

### <Filing Mode>

The image processing apparatus 10 causes the HDD 15 to store image data obtained by the image forming portion 100 and image data transferred from the external memory device 50 that is connected to the apparatus 10 via the communication portion 21. The stored image data is printed by the image forming portion 200, or is transferred to the client PC 60 via the NIC 23.

While the configuration of the image processing apparatus 10 having the image reading portion 100 and the image forming portion 200 is describe above, the present invention may be implemented by an apparatus having a document reading portion but not having an image forming portion (document reading apparatus), or, contrary to that, implemented by an apparatus having the image forming portion but not having the document reading portion (image forming apparatus). The document reading apparatus has an electrical configuration that is obtained by removing the image forming portion 200 from the block diagram of FIG. 2, and the image forming apparatus has an electrical configuration that is obtained by removing the image reading portion 100 from the block diagram of FIG. 2.

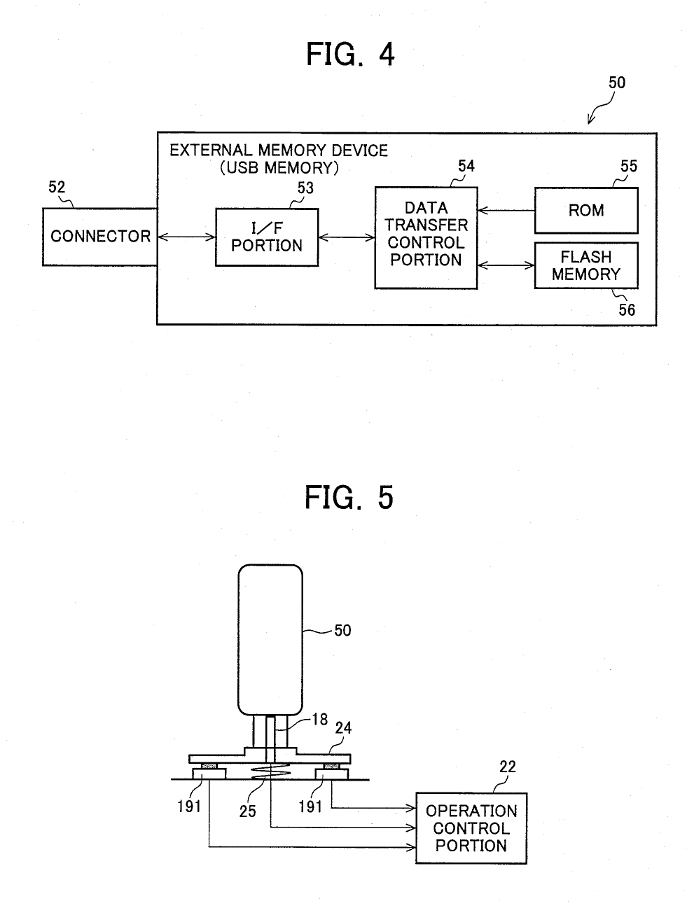

FIG. 4 is a block diagram of a configurative example of the external memory device. A USB memory is used as an example of the external memory device.

The external memory device 50 has the connector 52 connected to the connecting portion 18 of the image processing apparatus 10, an I/F portion 53 that controls communication between the external memory device 50 and the image processing apparatus 10, the flash memory 56 having image data stored thereon, and a data transfer control portion 54 that is provided as a CPU, etc., and that controls data reading from the flash memory 56 into the I/F portion 53 and data writing from the I/F portion 53 to the flash memory 56 based on a control program stored in the ROM 55. The data transfer control portion 54 carries out an authentication processing between the data transfer control portion 54 and the main CPU 11 of the image processing apparatus 10, permitting data transfer to and from the image processing apparatus 10 via the communication portion when authentication is successful.

An embodiment of the operating device for the electronic equipment of the present invention will be described.

In one embodiment of the present invention, the operating device for the electronic equipment is configured so that the external memory device, such as a USB memory, can be connected to the operating device. When a user operates the enclosure of the external memory device, the operating device reads a positional change of the enclosure to detect the operation carried out on the external memory device.

The external memory device stores the operation data for operating the electronic equipment in correlation with the external memory device. The operation data is the data from which a command for causing the electronic equipment to execute a given action can be created. In this operation data, the above described operation carried out on the external memory device is associated with the command for causing the electronic equipment to execute the given action.

When the external memory device is connected, the operating device for the electronic equipment detects a user operation carried out on the external memory device, and carries out control for sending a command for executing a given action to the electronic equipment based on the detected user operation and operation data read out of the external memory device. In this case, when the operation carried out on the external memory device is detected, a command corresponding to the operation is specified in the operation data read out of the external memory device. This allows the operating device for the electronic equipment to send the command corresponding to the operation carried out on the external memory device to the electronic equipment.

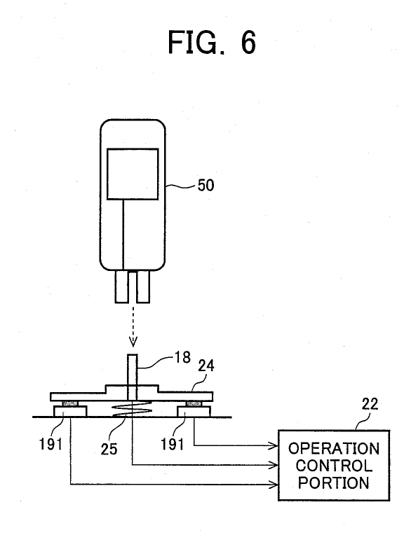

FIGS. 5 and 6 depict a configurative example of the connecting portion of the external memory device in the operating device for the electronic equipment of the present invention. In this example, a USB memory is used as the external memory device 50.

The external memory device 50 is configured to be connectable to the connecting portion 18 of the image processing apparatus 10, and is removable. FIG. 5 depicts the external memory device 50 that is in a state of connection to the connecting portion 18, and FIG. 6 depicts the external memory device 50 that is in a state of disconnection from the connecting portion 18.

The connecting portion 18 is provided as a connector to which the external memory device 50 can be connected, and is united to a connection portion base 24, which is supported with an elastic member (spring) 25 and can be changed in angle by an operation on the external memory device 50. Under the connection portion base 24, push-button switches 191 are disposed, which are pushed by the connection portion base 24 as it changes its angle. The push-button switches 191 are equivalent to the operation detecting portion 19 of FIG. 2.

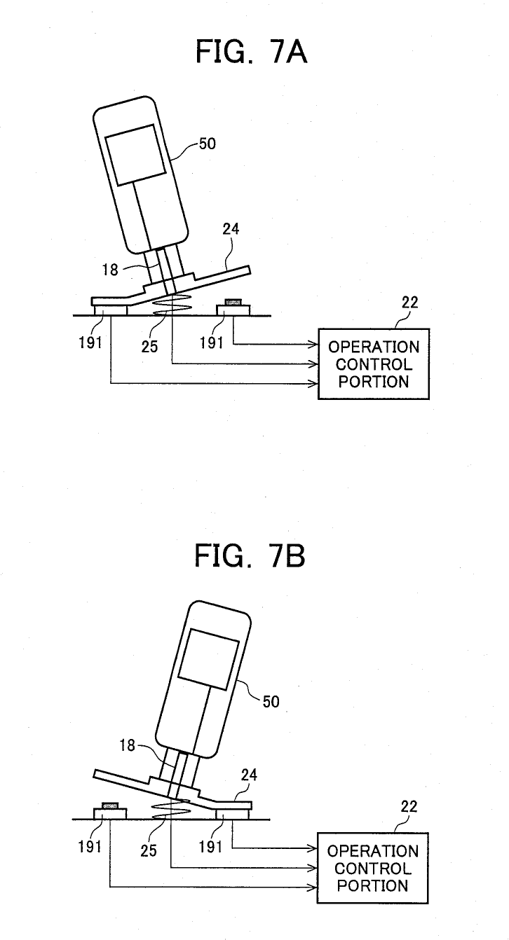

FIGS. 7A and 7B depict the external memory devices that are put in tilted state by the operation on the external memory device, showing the external memory devices in tilted state of FIG. 7A and that of FIG. 7B.

As described above, the connection portion base 24 united to the connecting portion 18 connected to the external memory device 50 can change in angle. Because of this, the user's operation of tilting the enclosure of the external memory device 50 causes the connection portion base 24 to tilt, resulting in pushing any one of the switches 191 serving as the operation detecting portion. At this time, the operation control portion 22 can detect the fact that any one of the switches 191 is pushed and determine the on state or off state of each of the switches 191.

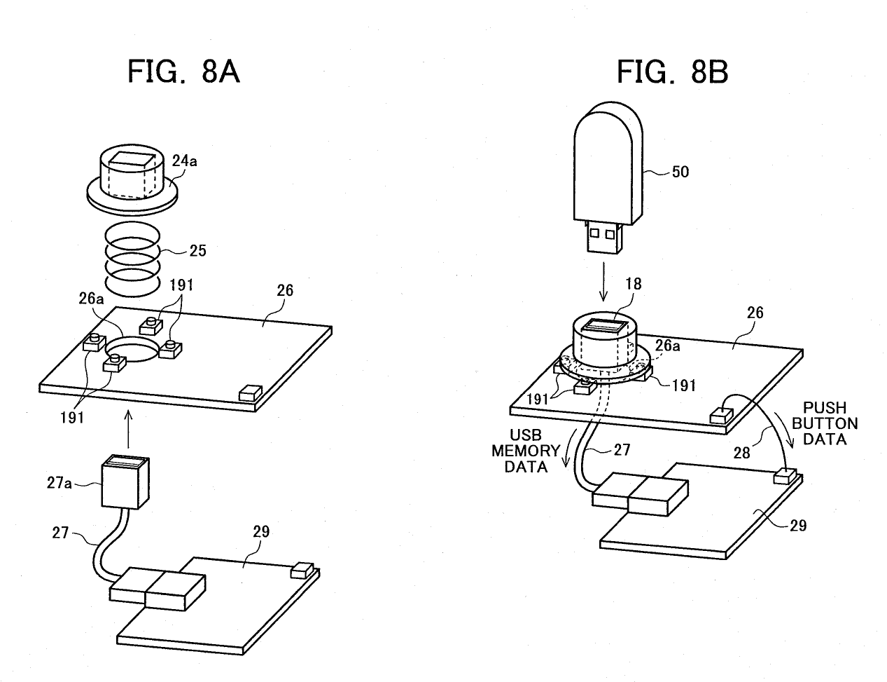

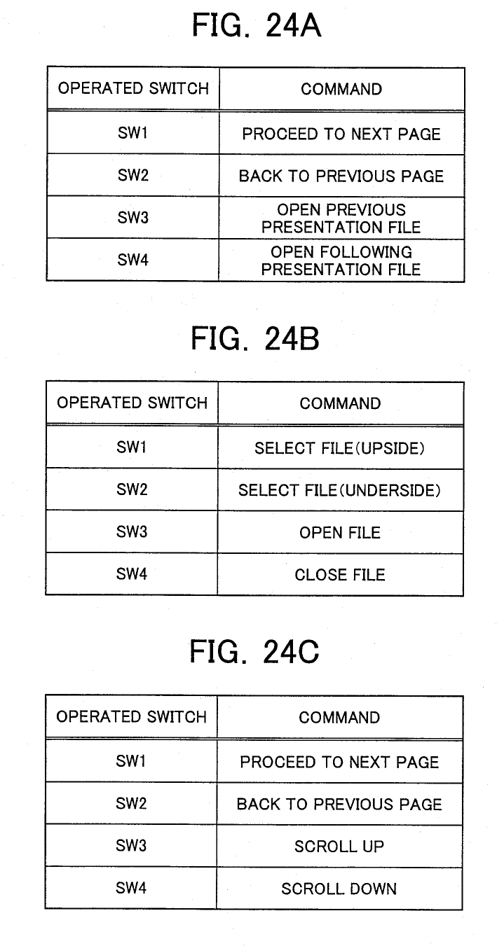

FIGS. 8A and 8B depict a more specific configurative example of the connecting portion for connection to the external memory device in the operating device for the electronic equipment of the present invention. FIG. 8A is a perspective schematic diagram of the resolved connecting portion for connection to the external memory device, and FIG. 8B is a perspective schematic diagram of the assembled connecting portion. In FIGS. 8A and 8B, 24a denotes a cap, 25 denotes a spring, 26 denotes a USB terminal inclination detecting board, 26a denotes a hole formed on the USB terminal inclination detecting board, 27 denotes a USB cable, 27a denotes a connector of the USB cable, 28 denotes a push-button data transmission line, and 29 denotes a controller.

As shown in FIG. 8A, four push-button switches 191 are arranged around the hole 26a on the USB terminal inclination detecting board 26, from the back side (underside) of which the connector 27a of the USB terminal cable 27 is inserted in the hole 26a. On the opposite side to the back side of the USB terminal inclination detecting board 26 (upside in FIGS. 8A and 8B), the spring 25 is disposed on the periphery of the hole 26a, and is capped with the cap 24a.

The connector 27a of the USB terminal cable 27 is plugged in the cap 24a, where the external memory device (USB memory) 50 can be connected to the connector 27a from above the cap 24a, which means that the connector 27a composes the connecting portion 18. The cap 24a is equivalent to the connecting portion base 24 of FIGS. 7A and 7B. The cap 24a is fixed by holding down the cap 24a with an outer jacket of a device (not shown).

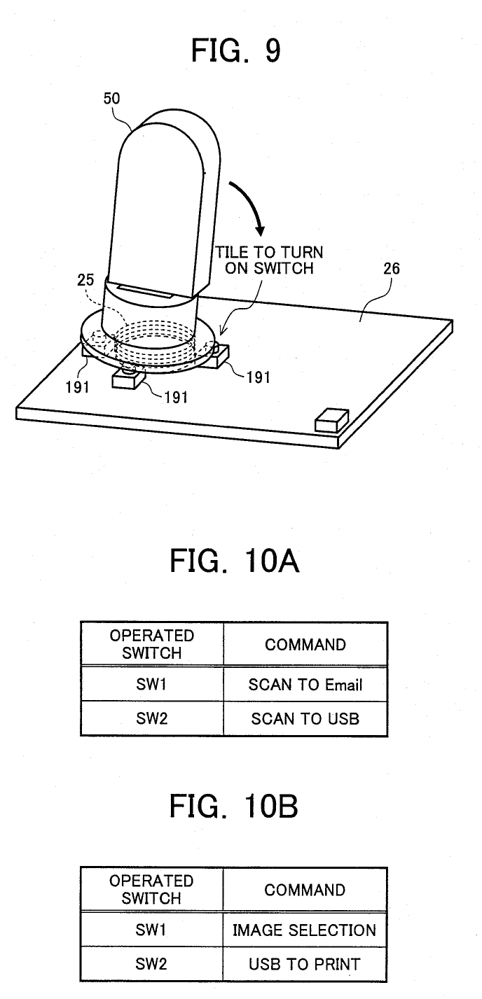

FIG. 9 is a diagram for explaining a tilted state of the external memory device having the configuration of FIGS. 8A and 8B. Four switches 191 are arranged so that pairs of switches are opposite to each other in the front-to-behind direction and in the left and right direction. As shown in FIGS. 7A and 7B, when the user tilts the external memory device 50 to cause the cap 24a to push any one of the switches 191, resulting push-button data is sent through the push-button data transmission line 28 of FIG. 8B to the controller 29. Data reading from a memory area of the external memory device 50 and data writing to the memory area is carried out through the USB cable 27 of FIGS. 8A and 8B. The controller 29 is provide with a circuit that offers the functions of the operation control portion 22, detecting portion 20, and communication portion 21 of FIG. 2.

While four switches 191 are provided in the above configurative example, the number and the position of switches 191 (i.e., operation detecting portion 19) may be determined properly in any desired manner. For example, the number of the switches 191 may be determined to be two, or to be a greater number of six or eight. A command to be given to the electronic equipment can be set for each of the switches 191, so that an increase in the number of switches leads to an increase in the number of commands to set.

FIGS. 10A and 10B depict examples of operation data stored in the external memory device 50, showing an operation data setting example of FIG. 10A and that of FIG. 10B that are different from each other.

In this case, two switches 191 are provided, and a command to be given to the electronic equipment is set for each switch (SW1, SW2). For example, in the setting example of FIG. 10A, “SCAN TO Email” is set as a command corresponding to pushing the switch SW1, and “SCAN TO USB” is set as a command corresponding to pushing the switch SW2. In the setting example of FIG. 10B, “image selection” is set as a command corresponding to pushing the switch SW1, and “USB TO PRINT” is set as a command corresponding to pushing the switch SW2.

In FIG. 10A, “SCAN TO Email” represents a mode in which image data read by the document reading portion of the image processing apparatus is sent by E-mail, and “SCAN TO USB” represents a mode in which image data read by the document reading portion of the image processing apparatus is stored in the external memory device 50.

The user connects the external memory device 50 to the connecting portion 18 of the operating device, and tilts the external memory device 50 to push the switch SW1. This user operation causes the image processing apparatus to execute the “SCAN TO Email” processing. Likewise, pushing the switch SW2 causes the image processing apparatus to execute the “SCAN TO USB” processing.

In FIG. 10B, “image selection” represents a mode in which a piece of image data to use is selected from a plurality of image data stored in the external memory device 50, and “USB TO PRINT” represents a mode in which image data stored in the external memory device 50 is formed into an image by the image forming portion of the image processing apparatus. For example, a list of image data stored in the external memory device 50 is displayed on an operation panel of the image processing apparatus, and the user pushes the switch SW1 to select a desired piece of image data, and then the user pushes the switch SW2 to cause the image processing apparatus to print the selected image data on a paper.

Commands set in operation data are not limited to the above examples, but other commands may also be set properly depending on the functions of the electronic equipment. Besides setting a command in correspondence to each switch, for example, another command setting is possible such that a specific command is given to the electronic equipment when a plurality of specific switches are pushed in a specific order.

As described above, detection results from the operation detecting portion 19 composed of switches, etc., and commands to be given to the electronic equipment (image processing apparatus in the above example) are associated with each other and are set in operation data stored beforehand in the external memory device 50. Because of this, a command corresponding to a detection result from the operation detecting portion 19 can be given to the electronic equipment.

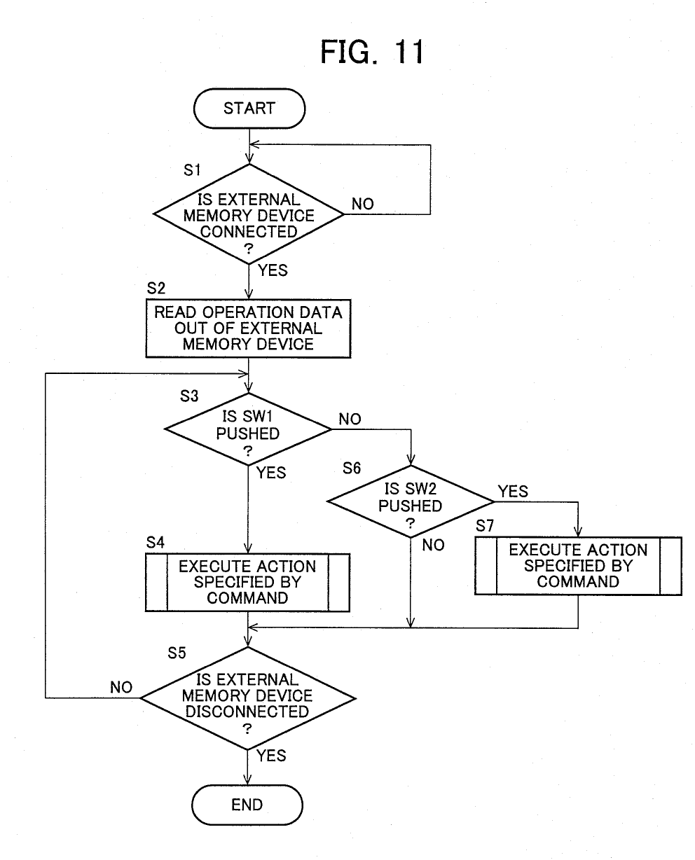

FIG. 11 is a flowchart for explaining an example of the processing carried out by the image processing apparatus having the operating device for the electronic equipment of the present invention. In this example, two switches (SW1, SW2) are provided, and a command is given to the image processing apparatus in correspondence to each switch.

When the detecting portion 20 of the operating device detects connection of the external memory device 50 (step S1), the operation control portion 22 of the operating device carries out control for reading out operation data stored in the external memory device 50 (step S2). In this example, the operation data is stored in the external memory device 50 in the use of specific file names.

When the operation control portion 22 of the operating device detects a push to the switch SW1 when the external memory device 50 is connected (YES at step S3), the operation control portion 22 refers to the operation data read out from the external memory device 50, and sends a command corresponding to the switch SW1 to the main CPU 11 of the image processing apparatus. Receiving the command, the main CPU 11 executes an action specified by the command (step S4). The operation control portion 22 then determines whether the external memory device 50 is disconnected (step S5), and when the external memory device 50 is not disconnected, returns to step S3. When the external memory device 50 is disconnected, the processing comes to an end.

Likewise, when the switch SW1 is not pushed at step S3 (NO at step S3) but the switch SW2 is pushed (YES at step S6), the operation control portion 22 refers to the operation data read out from the external memory device 50, and sends a command corresponding to the switch SW2 to the main CPU 11 of the image processing apparatus. Receiving the command, the main CPU 11 executes an action specified by the command (step S7). The operation control portion 22 then determines whether the external memory device 50 is disconnected (step S5), and when the external memory device 50 is not disconnected, returns to step S3. When none of the switches is pushed at step S6, whether the external memory device 50 is disconnected is also determined at step S5. When the external memory device 50 is disconnected, the processing comes to an end.

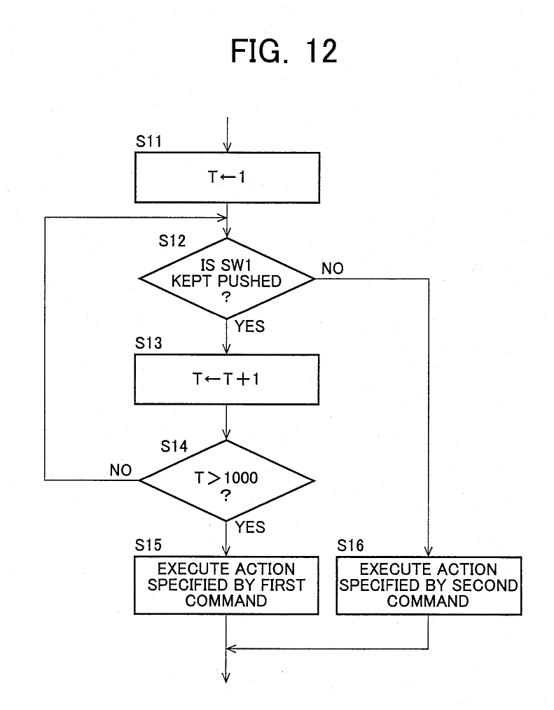

FIG. 12 is a flowchart for explaining another example of the processing carried out by the image processing apparatus having the operating device for the electronic equipment of the present invention, showing another example of the processing carried out at step S4 of FIG. 11.

In the example of FIG. 11, the operating device detects a push to a switch, and causes the image processing apparatus to execute a specific action through a command corresponding to the pushed switch. In this example, when the operating device detects a push or no push to a switch, the operating device changes a command to be given to the image processing apparatus depending on a case where a pushed state of a specific switch continues for a given time and a case where the pushed state of the specific switch continues not for the given time.

When connection of the external memory device 50 is detected at step S1, operation data is read out of the external memory device 50 at step S2, and it is detected at step S3 that the switch SW 1 is pushed, as shown in FIG. 11, the operation control portion 22 of the operating device carries out the processing of substituting 1 into a variable T at step S11 of FIG. 12. T is the variable representing a given time, which is, for example, 1 msec. The operation control portion 22 then determines whether a pushed state of the switch SW1 continues for a period from step S11 to the passage of the time T, or for a period from step S13 at which T is replaced with T+1, which will be described later, to the passage of the time T (step S12).

If the pushed state of the switch SW1 continues, T is replaced with T+1 (step S13). Then, whether T exceeds a given number (e.g., 1,000), that is, whether T>1,000 is satisfied is determined (step S14). When T>1,000 is not satisfied, the operation control portion 22 returns to step S12, it is further determined whether the pushed state of the switch SW1 continues for the time T.

When T>1,000 is satisfied, it means that the pushed state of the switch SW1 has continued for the given time T. The operation control portion 22, therefore, refers to the operation data read out of the external memory device 50, and sends a first command set for the switch SW1 to the main CPU 11 of the image processing apparatus. Receiving the command, the main CPU 11 executes an action specified by the first command for the switch SW1 (step S15). For example, the main CPU 11 executes the SCAN TO E-mail processing in response to the first command.

When the pushed state of the switch SW1 does not continue at step S12, on the other hand, the operation control portion 22 refers to the operation data read out of the external memory device 50, and sends a second command set for the switch SW1 to the main CPU 11 of the image processing apparatus. Receiving the command, the main CPU 11 executes an action specified by the second command for the switch SW1 (step S16). For example, the main CPU 11 executes the SCAN TO USE processing in response to the second command. The processing described above may also be set similarly in the processing that is to be carried out in response to a push to the switch SW2 at step S7 of FIG. 11.

In this example, two commands are set for one switch in the operation data stored in the external memory device 50, which means that the first command for the case of continuation of pushing the switch for the given time and the second command for the case of pushing the switch not for the given time are set in the operation data.

The operation control portion 22 reading out this operation data from the external memory device 50 detects a time of continuation of pushing the switch, and, depending on the time of continuation of pushing the switch, sends the first command for the switch or the second command for the switch to the main CPU 11 of the image processing apparatus.

As described above, changing a command depending on a time of continuation of pushing a switch allows setting two commands for one switch. In this case, setting a multiple of times of continuation of pushing switch enables setting three or more commands for one switch.

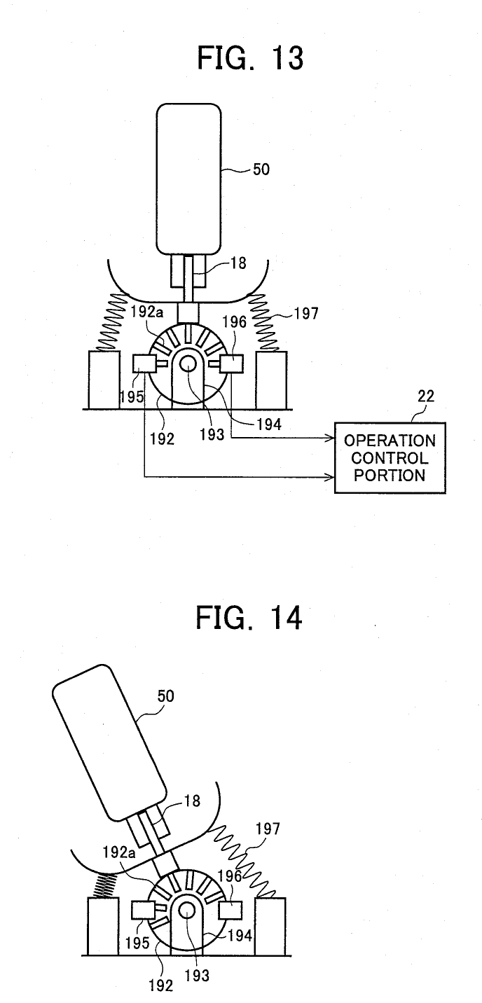

FIGS. 13 and 14 depict another configurative examples of the connecting portion for connection to the external memory device in the operating device for the electronic equipment of the present invention. FIG. 13 depicts the external memory device 50 that is in a state of connection to the connecting portion 18, and FIG. 14 depicts the external memory device 50 that is put in a tilted state by user operation. In both FIGS. 13 and 14, 192 denotes a rotary encoder, 192a denotes slits formed on the rotary encoder, 193 denotes the rotating shaft of the rotary encoder, 194 denotes a rotating shaft support, 195 denotes a first photointerrupter, 196 denotes a second photointerrupter, and 197 denotes a spring.

Similar to the above example, the external memory device 50 is configured to be connectable to the connecting portion 18 of the image processing apparatus 10, and is removable. In this example, the rotary encoder 192 is provided as a means equivalent to the operation detecting portion 19 that detects a positional change of the enclosure of the external memory device 50.

The connecting portion 18 is structured as the connector to which the external memory device 50 can be connected, and the connecting portion 18 can be tilted by operating the enclosure of the external memory device 50, which usually stands by itself at a position shown in FIG. 13 as a result of an action by the spring 197. The connecting portion 18 is coupled to the rotary encoder 192 that rotates around the rotating shaft 193 supported by the rotating shaft supporter 194. This means that tilting the external memory device 50 causes the rotary encoder 192 to rotate in an interlocking move with the tilting of the external memory device 50.

The rotary encoder 192 has a plurality of slits 192a. Light on-off signals output from two photointerrupters 195 and 196 take different waveforms depending on a case of light's passing through the slits 192a and a case of light's not passing through the slits 192a.

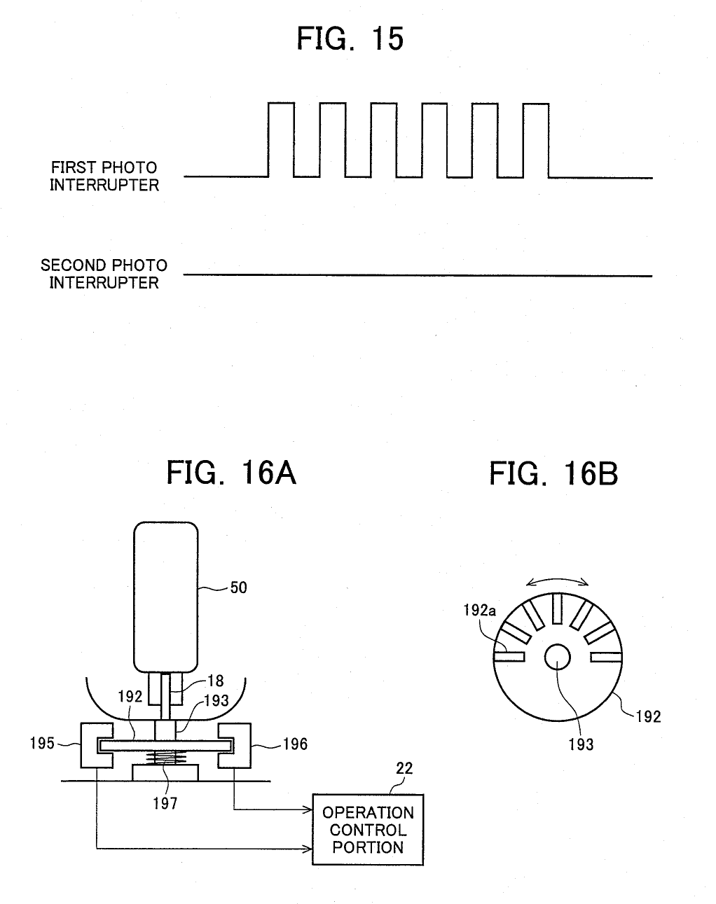

For example, when the external memory device 50 set in the state of FIG. 13 is tilted toward the first photointerrupter 195, as shown in FIG. 14, the photointerrupters 195 and 196 output pulse waveforms as shown in FIG. 15.

The operation control portion 22 is able to determine the direction and amount (angle) of an inclination of the external memory device 50 through a signal output from each of the photointerrupters 195 and 196. For example, the example of FIG. 15 demonstrates that six slits 192a formed on the rotary encoder 192 have passed a detection position of the first photointerrupter 195. When the external memory device 50 is tilted toward the second photointerrupter 196, a pulse waveform appears on an output signal from the second photointerrupter 196. The operation control portion 22 determines the amount of an inclination of the external memory device 50 based on the number of pulses.

According to the above configuration, the operation control portion 22 is able to detect a positional change of the enclosure of the external memory device 50 as an operation carried out on the external memory device 50.

The operation control portion 22 reads out operation data stored in the external memory device 50, and, based on the operation data and the operation carried out on the external memory device 50, carries out the processing of sending a command for executing a given action to the main CPU 11 of the image processing apparatus. This enables, for example, setting for increasing or decreasing the moving speed of a selection cursor at the time of menu selection according to the detected number of pulses (i.e., an angle of inclination of the external memory device 50).

FIGS. 16A and 16B depict still another configurative examples of the connecting portion for connection to the external memory device in the operating device for the electronic equipment of the present invention. FIG. 16A is a side view of the external memory device 50 that is in a state of connection to the connecting portion 18, and FIG. 16B is a top view of the rotary encoder of FIG. 16A. In FIGS. 16A and 16B, portions having the same functions as portions described in FIG. 13 are denoted by the same reference numerals.

Similar to the above example, the external memory device 50 is configured to be connectable to the connecting portion 18 of the image processing apparatus 10, and is removable. In this example, the rotary encoder 192 is also provided as the means equivalent to the operation detecting portion 19 that detects a positional change of the enclosure of the external memory device 50. The configuration in this example, however, is different from the configuration of FIG. 13 in the point that the rotary encoder 192 is disposed to be horizontally rotatable. Specifically, the rotating shaft of the rotary encoder 192 is along the longitudinal direction of the external memory device 50.

The connecting portion 18 is structured as the connector to which the external memory device 50 can be connected, and the connecting portion 18 can be rotated in the direction where the rotating shaft is along the longitudinal direction of the external memory device 50, by an operation carried out on the enclosure of the external memory device 50. The connecting portion 18 is coupled to the rotary encoder 192 that rotates around the rotating shaft 193, which means that rotating the external memory device 50 causes the rotary encoder 192 to rotate in an interlocking move with the rotation of the external memory device 50.

Similar to the example of FIG. 13, the rotary encoder 192 has a plurality of slits 192a, and light on-off signals output from two photointerrupters 195 and 196 take different waveforms depending on a case of light's passing through the slits 192a and a case of light's not passing through the slits 192a. The operation control portion 22 is able to determine the direction and amount (angle) of the rotation of the external memory device 50 through a signal output from each of the photointerrupters 195 and 196.

According to the above configuration, the operation control portion 22 is able to detect a positional change of the enclosure of the external memory device 50 as an operation carried out on the external memory device 50. The operation control portion 22 reads out operation data stored in the external memory device 50, and, based on the operation data and the operation carried out on the external memory device 50, carries out the processing of sending a command for executing a given action to the main CPU 11 of the image processing apparatus. This enables, for example, setting of increasing or decreasing the moving speed of the selection cursor at the time of menu selection according to the detected number of pulses (i.e., the extent of rotation of the external memory device 50).

Another example of the processing executed by the image processing apparatus having the operating device for the electronic equipment will then be described. When operation data is not stored in the external memory device 50, the action of sending a command for executing a given action to the image processing apparatus may be carried out based on an operation on the external memory device 50 detected by the operation detecting portion 19 and on predetermined operation data.

In the above described flowchart of FIG. 11, after the detecting portion 20 detects connection of the external memory device 50 at step 1, the operation control portion 22 carries out the control for reading out operation data stored in the external memory device 50 at step S2. When succeeding in reading the operation data out of the external memory device 50, the operation control portion 22 carries out the action of sending a command corresponding to an operation carried out on the external memory device 50 to the main CPU 11 based on the read out operation data, as described above.

At this time, if the operation data cannot be read out of the external memory device 50, for example, because the operation data is not stored in the external memory device 50, the command corresponding to the operation carried out on the external memory device 50 is sent to the main CPU 11 based on predetermined operation data. This predetermined operation data is stored, for example, in the ROM 13. For example, when the operation data cannot be read out of the external memory device 50, data reading/writing from/to the external memory device 50 may be carry out.

In this manner, the operation processing is changed easily depending on a case where the operation data can be read out of the external memory device 50 and a case where the operation data cannot be read out of the same. This improves operability.

Another configuration may be provided. According to the configuration, the action of reading out operation data from the external memory device 50 is not carried out but the operation data is kept stored beforehand in the operating device or the electronic equipment incorporating the operating device therein, and, when the external memory device 50 is connected and an operation is carried out on the external memory device 50, a command for executing specific data processing, such as reading or writing given data from or to the external memory device 50, is sent to the electronic equipment based on the operation detected by the operation detecting portion 19 and the operation data kept stored beforehand. In this case, storing the operation data in the external memory device 50 is not necessary. This case should be interpreted as the processing such that when the detecting portion 20 detects the insertion of the external memory device 50 in the connecting portion 18, the operation control portion 22 executes data reading or data writing from or to the external memory device 50.

For example, in a case where the operating device is incorporated in the image processing apparatus in the configuration of FIG. 6, when the operation control portion 22 of the operating device detects connection of the external memory device 50 to the connecting portion 18 and also detects that one of the switches 191 (SW1) is pushed, the operation control portion 22 sends, for example, a command for printing an image in the external memory device 50 (USB TO PRINT) to the main CPU 11 of the image processing apparatus. When it is detected that another one of the switches 191 (SW2) is pushed, the operation control portion 22 sends a command for executing the SCAN TO USB action to the main CPU 11 of the image processing apparatus.

In this case, the operation data for determining a command may be stored in a memory of the image processing apparatus, or may be stored in another memory that can be accessed by the operation control portion 22 of the operating device. When detecting an operation on the external memory device 50, the operation control portion 22 refers to the operation data to determine a command corresponding to the operation on the external memory device 50.

In this case, the configuration of the connecting portion 18 and operation detecting portion 19 to the external memory device 50 is realized not only as the configuration of FIG. 6, but may also be realized as the configuration of FIG. 13 or those of FIGS. 16A and 16B.

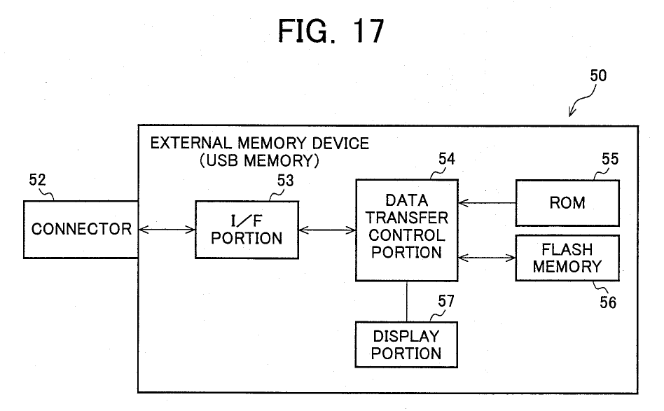

FIG. 17 is an explanatory view of one embodiment of an operating system for the electronic equipment of the present invention.

The operating system of this embodiment includes the operating device for the electronic equipment according to the above embodiments, and the external memory device 50 connectable to the operating device for the electronic equipment. As described above, a USB memory may be used as the external memory device 50.

The external memory device 50 of this embodiment is further provided with a display portion 57 that displays various data and information, in addition to the configuration shown in FIG. 4. The external memory device 50 thus has the connector 52 connected to the connecting portion 18 of the image processing apparatus 10, the I/F portion 53 that controls communication between the external memory device 50 and the image processing apparatus 10, the flash memory 56 having image data stored thereon, the data transfer control portion 54 that is provided as a CPU, etc., and that controls data reading from the flash memory 56 into the I/F portion 53 and data writing from the I/F portion 53 to the flash memory 56 based on a control program stored on the ROM 55, and the display portion 57 that displays a data list, etc., stored in the flash memory 56. The data transfer control portion 54 carries out the authentication processing between the main CPU 11 of the image processing apparatus 10 and the external memory device 50, permitting data transfer to and from the image processing apparatus 10 via the communication portion when authentication is successful.

In operation data that is stored in the external memory device 50 or in the operating device or the electronic equipment, a command for displaying the data list held in the external memory device 50 and a command for selecting a piece of data for causing the electronic equipment to execute a given action from the data list displayed by the display portion 57 are set in correspondence to operations carried out on the external memory device 50. In the same manner as in the above example, when a given operation is carried out on the external memory device 50, given data processing (e.g., printing and E-mail transmission by the image processing apparatus) is determined in advance properly for data that is selected through the operation.

In the same manner as in the above example, the operation control portion 22 of the operating device determines these commands based on the operation data. If a command is for the external memory device 50, the operation control portion 22 sends the command to the external memory device 50 via the connecting portion 18. According to the sent command, the data transfer control portion 54 of the external memory device causes the display portion 57 to display a list of data held in the flash memory 56 and selects a specific piece of data from the displayed data list. When the data list is displayed, the data list may be scrolled while being displayed in accepting data selection. When a specific operation is carried out on the external memory device 50, the operation control portion 22 of the operating device refers to the operation data, and sends a given command corresponding to the operation data to the electronic equipment (image processing apparatus, etc.), thereby causes electronic equipment to execute given data processing on the above selected data.

According to this system, the user is allowed to cause the electronic equipment to execute data processing on data stored in the external memory device 50 and data writing to the external memory device 50 in a proper manner by just making input operation while seeing display on the display portion 57 of the external memory device 50. This system may also be applicable to a configuration in which a display means is not incorporated in the operating device.

An embodiment of an information display apparatus and an external equipment connecting device of the present invention will then be described with reference to the drawings.

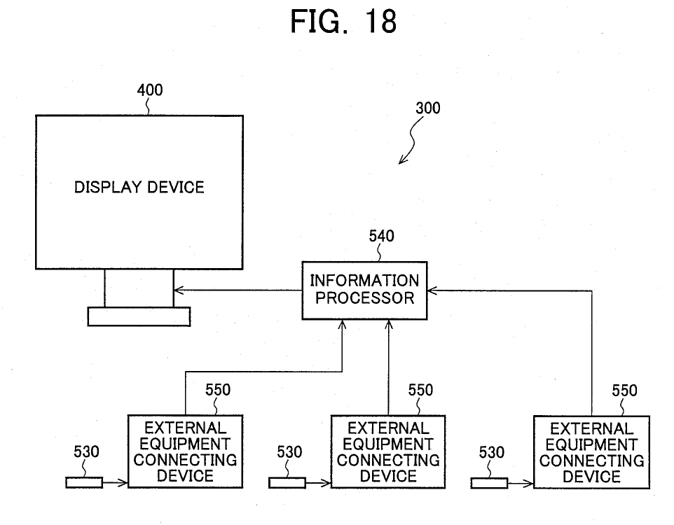

FIG. 18 is a schematic diagram of an information display system including the information display apparatus of the present invention. The information display system includes the information display apparatus 300 which has an external equipment connecting device 550 connectable to an external memory device 530 having stored thereon various data files and an information processor 540 that reads desired file data out of the external memory device 530 via the external equipment connecting device 550 to output a given image signal, and a display device 400 such as a liquid crystal display or a projector.

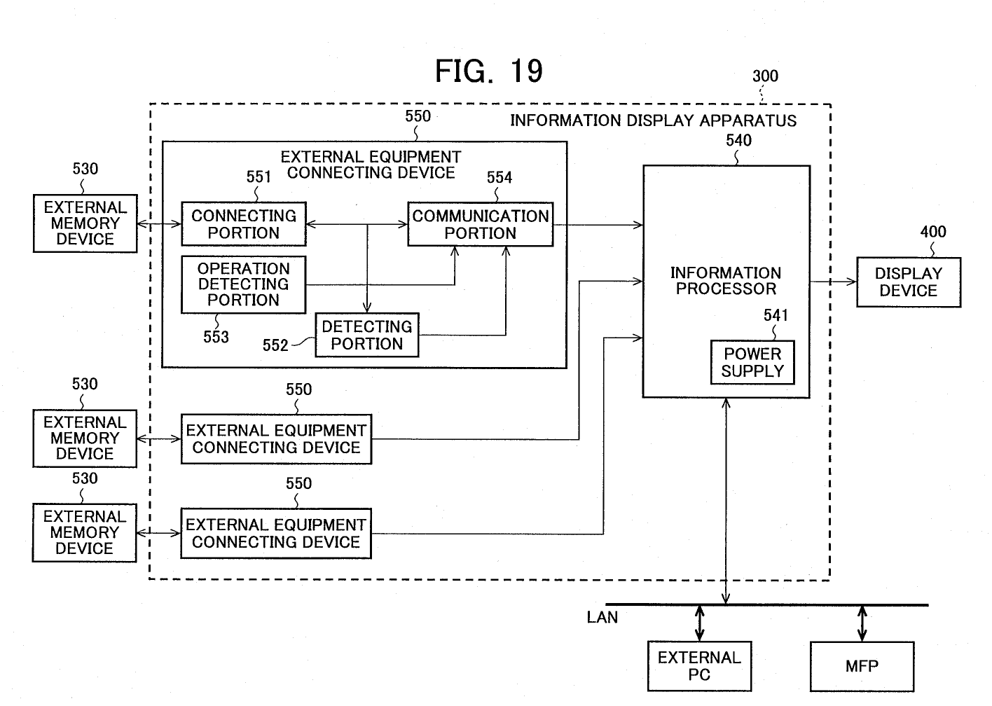

FIG. 19 is a block diagram of the overall configuration of the information display apparatus according to an embodiment of the present invention. The external equipment connecting device 550 has a connecting portion 551 provided as, for example, a USB standard connector that is connected to the external memory device 530 provided as a USB memory, etc., a detecting portion 552 serving as a circuit that detects the possibility or impossibility of data communication with the external memory device 530, an operation detecting portion 553 that detects a positional (postural) change of the enclosure of the connected external memory device 530 as an operation carried out on the external memory device 530, and a communication portion 554 serving as an interface that carries out data communication between the external memory device 530 and the information processor 540. The operation detecting portion 553 is united to the connecting portion 551, which will be described later, and is equivalent to switches SW1 to SW4 that are described later.

A single unit or a plurality of units of the external equipment connecting devices 550 may be connected to the information processor 540. For example, in a presentation, the external equipment connecting devices 550 of the number that is same as the number of presenters prepared for respective presenters are connected to the information processor 540, and each presenter, upon arrival of the presenter's turn, connects the external memory device to the external equipment connecting device 550 placed nearby to start his or her presentation. In this way, the presentation proceeds more smoothly and quickly.

If the information display apparatus 300 is connected to a LAN, image data output from the information processor 540 can be sent to an external PC or MFP.

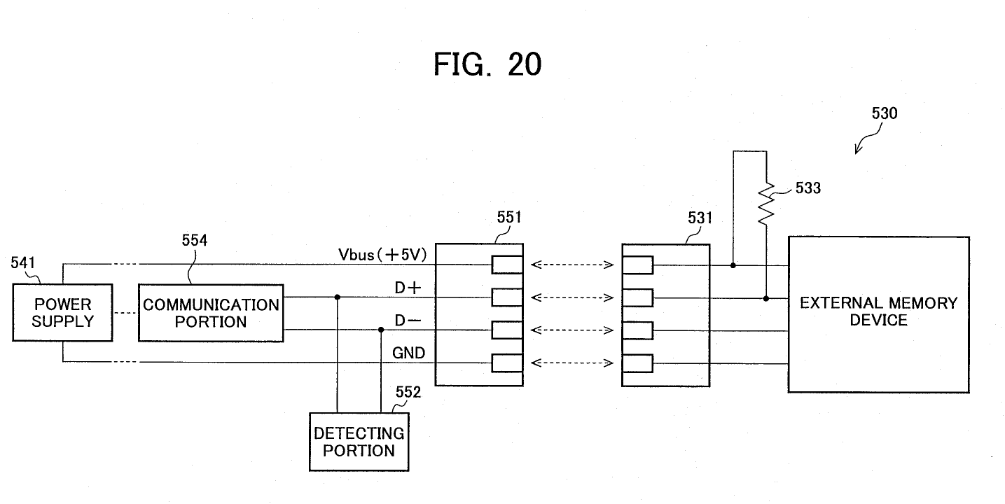

The detecting portion 552 that detects the possibility or impossibility of data communication with the external memory device 530 will then be described, referring to FIG. 20. In FIG. 20, a Vbus is a line (+5V) through which power is supplied to the external memory device 530. The information processor 540 has a power supply 541, which supplies power to the external memory device 530 via the Vbus. At the side of the external memory device 530, a pull-up resistance 533 is connected to a data input/output terminal D+ to pull up its voltage to the voltage of the Vbus. The pull-up resistance 533 may be connected to a data input/output terminal D−. When the external memory device 530 is connected to the connecting portion 551, the data input/output terminal D+ or the data input/output terminal D− comes to have a voltage virtually equal to the voltage of the Vbus. The detecting portion 552 detects the voltage of the data input/output terminal D+ and that of the data input/output terminal D−, and when finding that the voltages of the data input/output terminal D+ and the data input/output terminal D− are virtually equal to the voltage of the Vbus, informs the information processor 540 that data communication between the external memory device 530 and the information processor 540 is now possible via the communication portion 554.

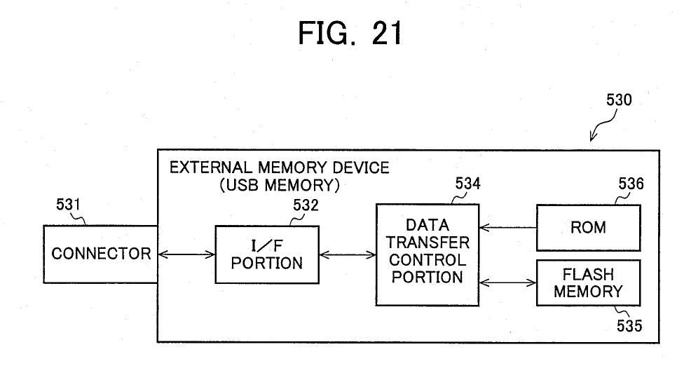

FIG. 21 is a block diagram of a configurative example of the external memory device 530. A USB memory is used as an example of the external memory device. The external memory device 530 has a connector 531 connected to the connecting portion 551 of the external equipment connecting device 550, an I/F portion 532 that controls communication between the external memory device 530 and the information processor 540, a flash memory 535 having image data stored thereon, and a data transfer control portion 534 that is provided as a CPU, etc., and that controls data reading from the flash memory 535 into the I/F portion 532 and data writing from the I/F portion 532 to the flash memory 535 according to a control program stored on a ROM 536. The data transfer control portion 534 carries out an authentication processing between the data transfer control portion 534 and the information processor 540, permitting data transfer to and from the information processor 540 via the communication portion 554 when authentication is successful.

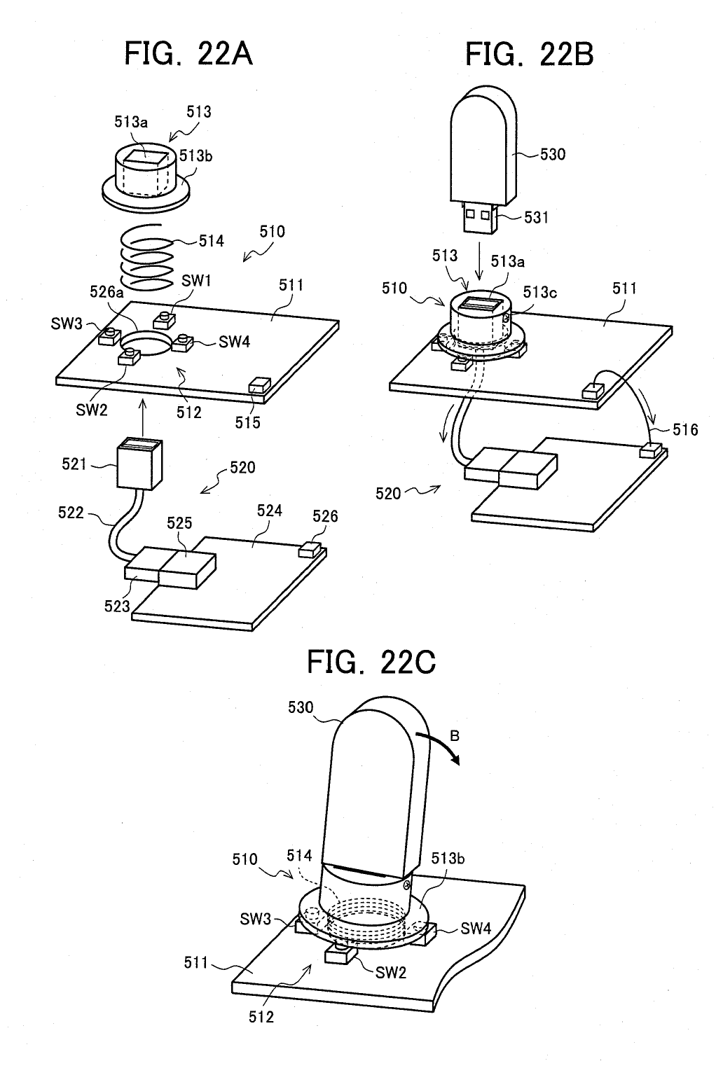

FIGS. 22A to 22C depict examples of a mechanism that the operation detecting portion 553 is united to the connecting portion 551 in the external equipment connecting device 550. In the following description, the external memory device 530 is described as a USB memory. As shown in FIGS. 22A and 22B, an operation detecting portion side unit 510 includes an inclination detecting board 511, four push-button switches 512 (SW1, SW2, SW3, and SW4) arranged around a through-hole 526a formed on the inclination detecting board 511, an opening 513a for a connector of the USB memory 530, a cap 513 having a flange 513b, a spring 514 disposed inside the cap 513, and a cable connection terminal 515 disposed on a corner of the inclination detecting board 511. A communication portion side unit 520 includes a USB female connector 521, a communication portion side board 524, a female connector 525 disposed on the communication portion side board 524, and a cable connection terminal 526 disposed on a corner of the communication portion side board 524.

In assembling the mechanism, the USB female connector 521 is inserted in the through-hole 526a of the board 511 from below, and is fitted into the cap 513 having the spring 514 placed inside thereof. The front end of the USB female connector 521 is then fitted to the opening 513a of the cap 513, and the cap 513 is pressed from above to cause the spring to contract to bring the bottom face of the flange 513b into uniform contact with four switches SW1, SW2, SW3, and SW4. In this state, the cap 513 is fixed with a machine screw 513c to complete the assembling.

The USB female connector 521 is connected to the female connector 525, which is fixed to the communication portion side board 524, via the USB cable 522 and the male connector 523. At the back of the inclination detecting board 511, a signal line (not shown) connected to the switches 512 (SW1, SW2, SW3, and SW4) is connected to the connection terminal 515. The cable connection terminal 515 disposed on the inclination detecting board 511 is connected to the cable connection terminal 526 disposed on the communication portion side board 524 through a signal cable 516.

At the operation detecting portion 553 configured in the above manner, when the connector 531 of the USB memory 530 is kept inserted in the USB female connector 521, and, for example, the USB memory 530 is pushed in the direction of an arrow B against the elastic force of the spring 514, as shown in FIG. 22C, and thereby, the USB memory 530 is tilted to cause the flange 513b of the cap 513 to push the switch SW4 and SW4 turns to on.

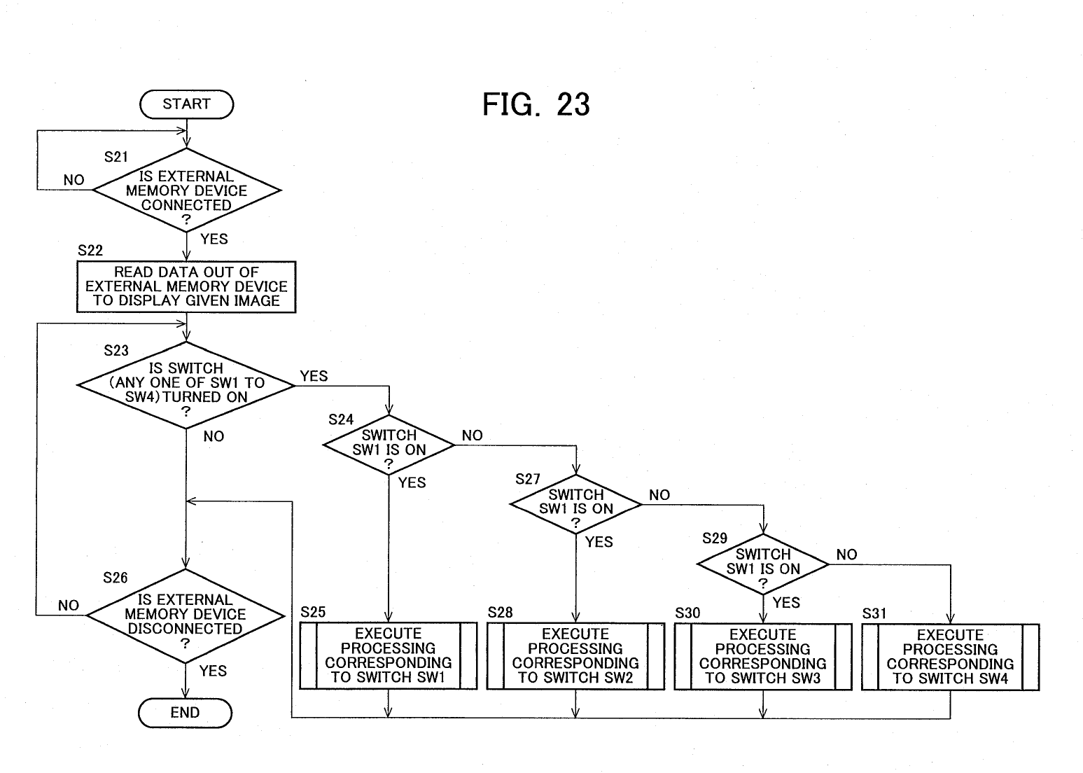

FIG. 23 is an example of control flow in the information processor 540 in a case where the external memory device 530 is connected to the connecting portion 551 of the external equipment connecting device 550 and a desired operation is carried out utilizing the above operation detecting function. FIGS. 24A to 24C depict examples of operation data stored in the external memory device 530. The operation data contain a system of commands at the time when a user tilts the USB memory of the external memory device connected to the external equipment connecting device and any one of the switches 512 (SW1, SW2, SW3, and SW4) is operated, as shown in FIG. 22C.

Referring to FIG. 23, when the detecting portion 552 detects connection of the external memory device 530 having the operation data stored therein to the connecting portion 551 (YES at step S21), the information processor 540 reads out the operation data together with files stored in the external memory device 530, and, for example, displays a file list on the display device 400 (step S22).

The operation data is stored with fixed file names attached thereto, and is provided in the form of, for example, tables shown in FIGS. 24A, 24B, 24C, and 24D. When given operation data is not stored in the external memory device, a default operation scheme is adopted. For example, any one of operation schemes shown in FIGS. 24A to 24C may be set on the information processor 540.

When an operation is carried out on the external memory device 530 while the file list is displayed on the display device 400 and it is detected that any one of the switches SW1 to SW4 (YES at step S23) is turned on and the detected switch is SW1 (step S24), the control flow proceeds to step S25 and the command corresponding to the switch SW1 is executed, and then proceeds to step S26. When disconnection of the external memory device 530 from the connecting portion 551 is not detected at step S26 (NO at step S26), the control flow returns to step S23. In the same manner, when a detected switch is any one of the switches SW2 to SW4, the above flow of steps are repeated in correspondence to each operation on the external memory device 530 until disconnection of the external memory device 530 from the connecting portion 551 is detected (steps S27 to S31).

At step S22, the function of the operation detecting portion may be allowed to be effective only when the operation data is stored. This setting prevents, for example, unnecessary display in a presentation even if a device irrelevant to operation (digital camera, etc.) in the presentation is connected through USB connection.

The external memory device 530 may record therein information that indicates the priority of operations. The information processor 540 reads the priority of operations to permit the highest priority operation on the external memory device. In this setup, no operational obstacle results even if a plurality of external memory devices are connected.

Priority may be registered with the external equipment connecting device. For example, a memory (not shown), such as flash memory, is connected to the communication portion 554 of each external equipment connecting device 550, and each memory stores different priority. The information processor 540 reads out such priority, and receives a command from the external memory device that is connected to the external equipment connecting device 550 having the highest priority when a plurality of external memory devices are connected. In this setup, no operational obstacle results even if a plurality of external memory devices are connected simultaneously.

The external memory device 530 may have recorded therein an authentication ID. The information processor 540 reads out the authentication ID from the external memory device 530, and when finding the recorded authentication ID to be usable, permits an operation on the external memory device 530. This eliminates an accident that an operation is carried out on an external memory device that is not authenticated as a user external memory device. Priority may be set based on an authentication ID.

The information processor 540 reads out identification information (extensions) appended to data files stored in the external memory device, and when the read identification information contains an extension that matches an extension indicating a specific file format, e.g., presentation file, sets the external equipment connecting device connected to the external memory device operable. Setting a specific file format, e.g., a presentation file format for extension matching prevents an external memory device having no recorded presentation file from mistakenly becoming operable even if the external memory device is connected.

If data files that are recorded in the external memory device of the highest priority or in an external memory device connected to the external equipment connecting device contain no data file of a specific file format, the information processor 540 reads out identification information of data files that are recorded in the external memory device of the second highest priority or in another external memory device connected to the external equipment connecting device, determines whether the read identification information indicates a specific file format, and when the identification information indicates the specific file format, sets the external memory device operable.

The operation data shown in FIGS. 24A to 24C will then be described in detail.

According to the operation data of FIG. 24A, for example, the processing of paging forward on the currently opened presentation file is carried out when the switch SW1 is pushed, the processing of paging backward on the currently opened presentation file is carried out when the switch SW2 is pushed, the processing of opening the file previous to the currently opened presentation file (file sequence is determined based on the sort order sequence of file names, preparation dates, etc.) is carried out when the switch SW3 is pushed, and the processing of opening the file following the currently opened presentation file is carried out when the switch SW4 is pushed.

According to the operation data of FIG. 24B, for example, a menu screen for file selection is displayed, a file on the menu screen is selected in correspondence to an operation of the switch SW1 and of the switch SW2, and the file opening processing is carried out through an operation of the switch SW3 while the file closing processing is carried out through an operation of the switch SW4.

The operation data of FIG. 24C represents a case where a Web browser is opened as application software. In this case, pushing the switch SW1 or SW2 turns a Web page, and pushing the switch SW3 or SW4 moves a scroll up or down.

Thus, the above operation data can be set in correspondence to the type of an opened file (started application). Specifically, when application software for a presentation is started, the operation data table shown in FIG. 24A is set.

When the Web browser is opened as application software, the processing of turning a Web page and moving the scrolls is carried out according to the operation data of FIG. 24C.

When a plurality of external equipment connecting devices 550 are connected to the information processor 540, an operational permission is set on each of the external equipment connecting devices 550 through a given operation. For example, if a presenter is near the external equipment connecting device (1) 550 (FIG. 18), operating the external equipment connecting devices (1) is permitted while operating the other external equipment connecting devices is forbidden. This prevents confusion in operating the external equipment connecting devices.

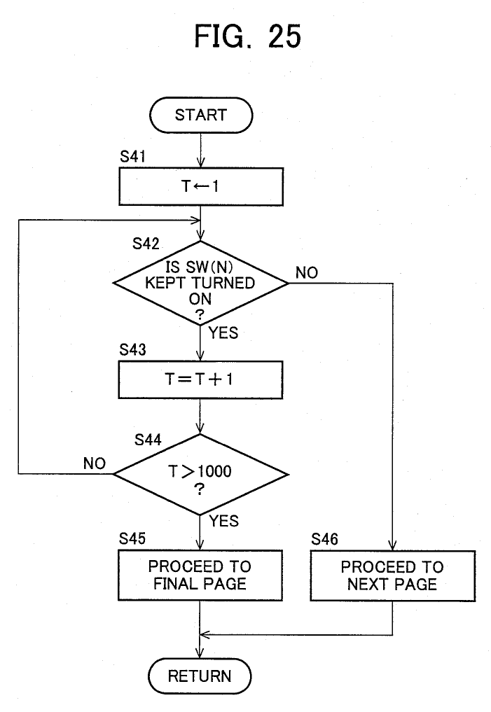

FIG. 25 depicts a control flow in an embodiment where one operation is continued for a given time or longer. Referring to steps S25, S28, S30, and S31 of FIG. 23, for example, when the switch SW1 is detected to be on at step S24, the control flow proceeds to step S41 of FIG. 25, at which 1 is substituted for a variable T. At step S42, whether an operation of turning on the switch SW1 continues for the given time or longer is detected, and when the operation continues, 1 is added to the variable T (step S43). When the operation continues until the variable T exceeds 1,000 (YES at step S44), the processing of proceeding to the final page is executed (step S45). If the operation does not continue for the given time at step S42, the processing of proceeding to the next page is executed (step S46).

In this manner, different processing can be executed using one switch.

In the configuration described in the above embodiments, the external equipment connecting device is connected to the information processor via the communication cable. The external equipment connecting device, however, may be united to the information processor.

The present invention offers the following effects.

The present invention provides an operating device for electronic equipment that allows execution of an intuitive, quick operation, an operating system and an image processing apparatus that have the operating device, an information display apparatus that allows execution of an intuitive, quick operation, and an external equipment connecting device used for the information display apparatus.

According to the present invention, particularly, a user is allowed to connect an external memory device to the operating device for the electronic equipment and use the external memory device itself as an operating lever. This saves the user from trouble of looking for an operating switch, menu display, etc., thus improves the operability of the electronic equipment.

According to the present invention, an operation is executed based on operation data stored in the external memory device. This allows an individual user to instantly execute a different operation when frequently used operations are different among users, thus improves operability. For example, when a user frequently uses a SCAN TO E-mail operation while another user frequently uses a USB TO PRINT operation, each user has an external memory device having stored therein different operation data to use such an external memory device for each user operation. This allows an individual user to easily execute a different operation.

According to the present invention, an action of reading operation data from the external memory device is not carried out, but the operation data is kept stored beforehand in the operating device or in the electronic equipment incorporating the operating device therein, and when the external memory device is connected and is operated, a specific command is given to the electronic equipment based on the operation data stored beforehand. This enables predetermination of data processing that is automatically executed in response to a specific operation on the external memory device, so that a specific operation by the electronic equipment can be executed by just operating the external memory device.

According to the present invention, whether an operation carried out on the external memory device is continued for a given time is determined, and a command to be given to the electronic equipment is changed depending on a case of continuation of the operation for the given time and a case of continuation of the operation not for the given time. This allows setting two or more commands for one operation.

According to the present invention, when operation data is not stored in the external memory device, the electronic equipment is caused to carry out a given action based on predetermined operation data. As a result, the operational process is changed easily depending on a case where the operation data can be read out of the external memory device and a case where the operation data cannot be read out of the same. This improves operability.

According to the present invention, the external memory device is provided with a display portion capable of displaying a list of storage data, which enables an operation of displaying the list of data held in the external memory device and an operation of selecting a piece of data from the displayed data list. A user, therefore, can properly execute data processing on the storage data in the external memory device and data writing to the external memory device by just making input operation while seeing display on the external memory device. This improves operability.

The present invention enables a user to operate the information display apparatus intuitively and quickly even if the user is not accustomed to the information display apparatus, thus allowing the user to make a presentation, etc., efficiently.

1. An operating device for electronic equipment that causes the electronic equipment to execute a given action, comprising:
a connecting portion connectable to an external memory device;
an operation detecting portion that detects a positional change of an enclosure of an external memory device connected to the connecting portion as an operation carried out on the external memory device; and
a control portion that sends a command for executing a specific action to the electronic equipment in correspondence to a detection result from the operation detecting portion, wherein
the control portion gives a command corresponding to an operation detected by the operation detecting portion to the electronic equipment based on operation data that is set so that when an operation on the external memory device is detected, a command corresponding to the operation is specified.

2. The operating device for electronic equipment as defined in claim 1, wherein
the operation data is stored in the external memory device, and wherein
the control portion reads out the operation data from the connected external memory device, and sends a command corresponding to an operation detected by the operation detecting portion to the electronic equipment based on the read operation data.

3. The operating device for electronic equipment as defined in claim 1, comprising a detecting portion that detects whether the external memory device is connected, wherein
when the detecting portion detects connection of the external memory device, the control portion changes an operational mode to a mode for carrying out an action of sending a command corresponding to an operation detected by the operation detecting portion to the electronic equipment based on the operation data.

4. The operating device for electronic equipment as defined in claim 1, wherein
the operation detecting portion detects a tilt direction of the enclosure of the external memory device as the positional change.

5. The operating device for electronic equipment as defined in claim 1, wherein
the operation detecting portion detects a tilt angle of the enclosure of the external memory device as the positional change.

6. The operating device for electronic equipment as defined in claim 1, wherein
the operation detecting portion detects an angle of rotation around a rotating shaft along the longitudinal direction of the enclosure of the external memory device as the positional change.

7. The operating device for electronic equipment as defined in claim 5, wherein
the control portion determines whether an operation carried out on the external memory device continues for a given time, and changes a command to be given to the electronic equipment depending on a case of continuation of the operation for the given time and a case of continuation of the operation not for the given time.

8. The operating device for electronic equipment as defined in claim 1, wherein
when the operation data is stored in the external memory device, the control portion carries out an action of sending a command corresponding to an operation detected by the operation detecting portion to the electronic equipment based on operation data read out of the external memory device, and wherein
when the operation data is not stored in the external memory device, the control portion carries out an action of sending a command corresponding to an operation detected by the operation detecting portion to the electronic equipment based on predetermined operation data.

9. An operating system for electronic equipment, comprising the operating device for electronic equipment as defined in claim 1, and an external memory device connectable to the operating device for electronic equipment, wherein
the external memory device has a display portion capable of displaying a list of data stored in the external memory device, and wherein
a command for displaying the data list stored in the external memory device and a command for selecting a piece of data for causing the electronic equipment to carry out a given action from the data list displayed by the display portion are set in the operation data in correspondence to an operation on the external memory device.

10. An image processing apparatus comprising the operating device for electronic equipment as defined in claim 1.

11. An image processing apparatus comprising the operating system for electronic equipment as defined in claim 9.

12. An information display apparatus comprising:
an information processor that carries out control for reading out operation data and a data file stored in an external memory device to display a desired image; and
an external equipment connecting device including a connecting portion connectable to an external memory device, and an operation detecting portion that detects a positional change of an enclosure of an external memory device connected to the connecting portion as an operation carried out on the external memory device, the operation detecting portion being attached integrally to the connecting portion, wherein
the operation data is data that is preset so that when the operation detecting portion detects an operation on an external memory device, a command corresponding to the operation is specified, and wherein
the information processor reads the operation data out of an external memory device connected to the connecting portion, and executes a command corresponding to an operation detected by the operation detecting portion based on the read operation data.

13. The information display apparatus as defined in claim 12, wherein
the information processor changes a command system for executing a specific action in correspondence to application software running, and executes a command according to a detection result from the operation detecting portion.

14. The information display apparatus as defined in claim 12, comprising a plurality of the external equipment connecting devices, wherein
the information processor can determine possibility and impossibility of operation on each of the external equipment connecting devices.

15. The information display apparatus as defined in claim 12, wherein
when given operation data is not stored in an external memory device, the information processor executes processing based on a given command system set in the external memory device.

16. The information display apparatus as defined in claim 12, wherein
when detecting connection of a plurality of external memory devices having stored therein the operation data, the information processor enables operation of the external equipment connecting device connected to an external memory device based on priority registered with the external memory device.

17. The information display apparatus as defined in claim 12, wherein
when detecting connection of a plurality of external memory devices having stored therein operation data, the information processor enables operation of the external equipment connection device connected to an external memory device based on priority registered with the external equipment connecting device.

18. The information display apparatus as defined in claim 12, wherein
when detecting an authentication ID stored in an external memory device to be a usable authentication ID registered with the external memory device, the information processor enables operation of the external equipment connecting device connected to the external memory device.

19. The information display apparatus as defined in claim 12, wherein
the information processor reads out identification information of a data file stored in an external memory device, and when the read identification information matches a specific file format, enables operation of the external equipment connecting device connected to the external memory device.

20. The information display apparatus as defined in claim 12, wherein
when detecting continuation of a given operation on the external equipment connecting device for a given time or longer, the information processor executes another processing.

21. An external equipment connecting device used for an information display apparatus that reads out operation data and a data file stored in an connected external memory device to display a desired image, comprising:
a connecting portion connected separably to an external memory device; and
an operation detecting portion that is attached integrally to the connecting portion and that detects a positional change of an enclosure of an external memory device connected to the connecting portion as an operation carried out on the external memory device.

22. The external equipment connecting device as defined in claim 21, wherein
the operation detecting portion includes a mechanism that when an operation is carried out on an external memory device connected to the connecting portion, causes the connecting portion to tilt with the external memory device, and a plurality of switches each of which detects a tilt of the connecting portion in each direction.

23. The external equipment connecting device as defined in claim 21, comprising a communication portion that enables data communication between an external memory device and an information display apparatus.

24. The external equipment connecting device as defined in claim 23, comprising a detecting portion that detects possibility and impossibility of the data communication.
